(19) United States
(12) Patent Application Publication
(10) Pub. No.: US 2017/0097489 A1
(43) Pub. Date: Apr. 6, 2017

(54) LOW INTERFERENCE OPTICAL MOUNT

(71) Applicant: NEWPORT CORPORATION, Irvine, CA (US)

(72) Inventors: Rick SEBASTIAN, Costa Mesa, CA (US); Wen Xu JIN, Laguna Hills, CA (US); Arthur Robert PROCHNOW, Cypress, CA (US)

(73) Assignee: NEWPORT CORPORATION, Irvine, CA (US)

(21) Appl. No.: 15/315,711

(22) PCT Filed: Jun. 2, 2015
(86) PCT No.: PCT/US2015/033837

§ 371 Date: Dec. 1, 2016

Related U.S. Application Data
(60) Provisional application No. 62/008,059, filed on Jun. 5, 2014.

(51) Int. Cl. G02B 7/00; G02B 5/00

(52) U.S. Cl. CPC G02B 7/006; G02B 5/005

(57) ABSTRACT

A low interference optical mount assembly that permits the mounting of one or more optics in a stable clamped configuration while minimizing the amount of surface area of the optic obscured by an optic mount of the assembly. Clamp embodiments for such an assembly may include a resilient leaf spring or a rigid clamp plate. In some cases, the mount assembly may be configured in a wheel arrangement that allows the selection of multiple optics by rotating a support frame that supports a plurality of optic mounts.

### RELATED PATENT APPLICATION(S)

This application is a national stage application under 35 U.S.C. section 371 of International Patent Application No. PCT/US2015/033837, filed Jun. 2, 2015, naming Rick Sebastian et al. as inventors, titled “Low Interference Optical Mount”, and designated by Attorney Docket No. NPT-0341-PC, which claims priority from U.S. Provisional Patent Application No. 62/008,059, filed Jun. 5, 2014, naming Rick Sebastian et al. as inventors and titled “Low Interference Optical Mount”, both of which are incorporated by reference herein in their entirety.

### BACKGROUND

Optical mount assemblies may be used in order to secure optical elements such as lenses, filters, mirrors and the like to a given optical apparatus such as an optical bench. An optical element may be secured to a respective optical mount assembly which may in turn be secured to the given optical apparatus. Some optical mount assemblies may be configured to secure to multiple optical elements simultaneously.

The adjustment of the position of the optical elements may allow for the optimization of the position of the optical elements with respect to lasers, cameras, detectors and the like which may also be secured to the optical apparatus. As an example a laser may have an output which is configured as an optical beam, with the optical beam having properties which may include optical beam direction, optical beam divergence, and a spectral bandwidth of the optical beam. The optical beam may interact with optical elements of the optical apparatus such that the various properties of the beam may be altered. For example the optical beam direction may be changed after the optical beam interacts with an optical element which is configured as a mirror. Alternatively, the spectral bandwidth of the optical beam may be diminished after the beam interacts with an optical element which is configured as a filter. In each case the properties (direction, spectral bandwidth) of the optical beam are changed by the interaction of the beam with at least one active surface (most optical elements have two active surfaces) of the given optical element, with the active surface of the optical element having been configured to alter the beam properties accordingly.

One limitation of some current optical mounts is difficulty in loading an optical element into the optical mount. Some current optical mounts may include at least one threaded annular receptacle into which an optical element can be inserted. A threaded locking ring may then be attached to the threaded annular receptacle thereby securing the optical element between the threaded locking ring and the threaded annular receptacle. Both the threaded annular receptacle and the threaded annular ring may include circular access windows which expose a portion of each active surface of the optical element. The circular access windows act to confine the optical element between the threaded annular receptacle and the threaded locking ring, however as another limitation of current optical mounts the circular access windows mask a significant portion (in some cases up to 25% or more) of the active surface area around the entire circumference of the optical element. This masking of active surface area can be exacerbated if an optical beam impinges upon the optical element at an angle which is not perpendicular to the active surface of the optical element. In such an instance, the material of the optical mount may interfere with the optical beam. Thus the access windows of optical mounts may effectively reduce the active surface of optical elements which are struck by oblique optical beams by a factor of up to 50% or more. What have been needed are optical mount assemblies which are configured to secure to optical elements such that a minimum active surface area of the optical element is masked. Additionally, the process of attaching the optical elements to the optical mounts should be simplified.

### SUMMARY

Some embodiments of a low interference optical mount assembly for mounting a plurality of optics may include a base member and a rigid rotating support frame which is rotatably coupled to the base member. The rigid rotating support frame may rotate about an axis of rotation which is centrally located on the rotating support frame. The low interference optical mount assembly may include a plurality of low interference optic mounts which are circumferentially disposed about and in fixed relation to the rotating support frame. Each optic mount may be disposed at a common radius from the axis of rotation of the rotating support frame. Each optic mount may include an optic mount body which in turn may include a datum surface which is disposed along an outer radial edge of the optic mount body. The datum surface may lie in a plane which is perpendicular to the axis of rotation of the rotating support frame. The datum surface may also be configured to contact a partial outer edge of an optic and leave a majority of a perimeter of an optic free of contact. Each optic mount may also include an optic stop structure which extends from the plane of the datum surface. The optic stop structure may further be disposed in fixed relation to the datum surface, and may also bound an inner radial boundary of the datum surface. The optic stop structure may also provide a surface against which an outer edge of an optic which is to be mounted to the optical mount makes contact. The optic mount may also include a clamp with at least one contact point which is disposed in opposition to the datum surface. Each contact point of the clamp may be moveable relative to the datum surface in a direction which is generally perpendicular to the datum surface. In addition, each contact point may be configured to releasably and controllably clamp an optic between the contact point and the datum surface.

Some embodiments of a low interference optical mount may include an optic mount body which may have a datum surface which is disposed along an outer edge of the optic mount body. The datum surface may be configured to contact a partial outer surface of an optic and leave a majority of a perimeter of an optic free of contact. The low interference optic mount may also include an optic stop structure which extends from the plane of the datum surface and which is disposed in fixed relation to the datum surface. The optic stop structure may also bound an inner boundary of the datum surface and provide a surface against which an outer edge of an optic to be mounted makes contact. The low interference optic mount may also include a clamp which is disposed such that it is in opposition to the datum surface. The clamp may be moveable relative to the datum surface in a direction which is generally perpendicular to the datum surface, and the clamp may be configured to releasably and controllably clamp an optic between at least one contact point of the clamp and the datum surface. The clamp may include a resilient leaf spring which may have an inner radial portion which is secured in fixed relation relative to the optic mount body. The clamp may also have an outer radial portion which comprises at least one contact point which is disposed in opposition to the datum surface and which is resiliently moveable relative to the datum surface. The clamp may also include a clamp screw which has a threaded shaft that passes through a clearance hole in the resilient leaf spring, and which is threadedly engaged with a mating threaded hole in the optic mount body. Tightening the clamp screw overcomes a resilient spring resistance of the leaf spring and forces the outer radial portion of the leaf spring closer to the datum surface to releasably clamp an optic between at least one contact point of the clamp and the datum surface.

Some embodiments of a low interference optic mount may include an optic mount body which incorporates a datum surface which is disposed along an outer edge of the optic mount body. The datum surface may be configured to contact a partial outer surface of an optic and leave a majority of a perimeter of an optic free of contact. The low interference optic mount may also include an optic stop structure which extends from the plane of the datum surface, and which is disposed in fixed relation to the datum surface. The optic stop structure may bound an inner boundary of the datum surface and may provide a surface against which an outer edge of an optic to be mounted can make contact. The low interference optic mount may also include a clamp which is disposed in opposition to the datum surface, and which is moveable relative to the datum surface in a direction which is generally perpendicular to the datum surface. The clamp may be configured to releasably and controllably clamp an optic between at least one contact point of the clamp and the datum surface. The clamp may also include a rigid clamp plate which has an outer radial portion which comprises at least one contact point which is disposed in opposition to the datum surface. The clamp plate may be moveable relative to the datum surface in a direction which is substantially perpendicular to the datum surface. The clamp may also include a clamp screw that rotates relative to the optic mount body while being substantially axially fixed relative to the optic mount body. The clamp screw may have a threaded shaft which is threadedly engaged with a threaded hole of the clamp plate such that rotation of the clamp screw induces relative displacement between the clamp plate and the optic mount body. Tightening the clamp screw may force the outer radial portion of the clamp plate closer to the datum surface in order to releasably clamp an optic between at least one contact point and the datum surface.

Some embodiments of a low interference optic mount may include an optic mount body which has a datum surface which is disposed along an outer edge of the optic mount body. The datum surface may be configured to contact a partial outer surface of an optic and leave a majority of a perimeter of an optic free of contact. The low interference optic mount may also include an optic stop structure which extends from the plane of the datum surface and which is disposed in fixed relation to the datum surface. The optic stop structure may bound an inner boundary of the datum surface and may provide a surface against which an outer edge of an optic to be mounted can make contact. The low interference optic mount may also include a clamp which is disposed in opposition to the datum surface and which is moveable relative to the datum surface in a direction which is generally perpendicular to the datum surface. The clamp may be configured to releasably and controllably clamp an optic between at least one contact point of the clamp and the datum surface. The clamp may include a rigid clamp plate which has an inner radial portion which is disposed in a pivoting but axially fixed relation relative to the optic mount body. The rigid clamp plate may have an outer radial portion which comprises at least one contact point which is disposed in opposition to the datum surface and which is moveable relative to the datum surface. The clamp may also include a resilient tension member which is operatively coupled between the optic mount body and clamp plate. The resilient tension member may be configured to exert a resilient bias clamping tension between the optic mount body and the clamp plate that pulls the outer radial portion of the clamp plate closer to the datum surface in order to releasably clamp an optic between at least one contact point of the clamp and the datum surface.

Some embodiments of a low interference optical mount assembly for mounting a plurality of optics may include a base member. The low interference optical mount assembly may also include a rigid rotating support plate which is rotatably coupled to the base member and which is configured to rotate about an axis of rotation of the rotating support plate. The rotating support plate may include a datum surface which is disposed along an outer radial edge of the support plate, with the datum surface lying in a plane which is substantially perpendicular to the axis of rotation. The low interference optical mount may also include a clamp plate which is disposed such that it is adjacent the support plate and which is configured to releasably and controllably clamp an optic to the datum surface. The clamp plate may be moveable relative to the datum surface in a direction which is generally perpendicular to the datum surface. The clamp plate may include a plurality of optic receptacles, with each optic receptacle including a contact surface which is disposed in opposition to the datum surface. Each optic receptacle may be configured to engage a partial outer edge of an optic and to leave a majority of a perimeter of the optic free of contact. Each optic receptacle may include an optic stop structure that extends from a plane of the contact surface and which is disposed in fixed relation to the contact surface. The optic stop structure may bound an inner radial boundary of the contact surface and may provide a surface against which an outer edge of an optic which is to be mounted can make contact. The low interference optical mount may also include a clamp mechanism that is operatively coupled between the clamp plate and the support plate, and which is configured to controllably compress the contact surfaces of the clamp plate towards the datum surface of the support plate.

Certain embodiments are described further in the following description, examples, claims and drawings. These features of embodiments will become more apparent from the following detailed description when taken in conjunction with the accompanying exemplary drawings.

### BRIEF DESCRIPTION OF THE DRAWINGS

The drawings illustrate embodiments of the technology and are not limiting. For clarity and ease of illustration, the drawings may not be made to scale and, in some instances, various aspects may be shown exaggerated or enlarged to facilitate an understanding of particular embodiments.

FIG. 1 is a perspective view of an embodiment of a low interference optical mount assembly which is secured to an optical bench and which has a plurality of optical elements secured thereto.

FIG. 2 is a perspective view of the low interference optical mount of FIG. 1 which is shown without the optical elements and the optical bench.

FIGS. 3 and 4 are front and side elevation views of the low interference optical mount assembly of FIG. 2.

FIG. 5 is a perspective view of a rotating support frame assembly.

FIG. 6 is an elevation view of an embodiment of a rotating support frame.

FIG. 7 is a perspective view of the rotating support frame embodiment of FIG. 6.

FIG. 8 is a perspective view of an embodiment of a leaf spring plate.

FIG. 9 is a schematic view of an optical element which depicts a percentage of a useable surface of the optical element which may be occupied by an optical mount (not shown).

FIG. 10 is a schematic view of an optical element which depicts a percentage of a useable surface of the optical element which may be occupied by commercially available optical mounts (not shown).

FIG. 11 is a schematic view in elevation of an optical element which is disposed in a commercially available type optical mount.

FIG. 12 is a schematic top view of the optical element and optical mount of FIG. 11 as well as an optical beam source which is emitting multiple beams towards the optical element.

FIG. 13 is a section view of the low interference optical mount assembly of FIG. 3.

FIG. 14 is an enlarged view of FIG. 13 which depicts an optical mount assembly embodiment.

FIG. 15 is an enlarged view of FIG. 13 which also includes an optical element which is mounted to the optical mount assembly embodiment of FIG. 3.

FIG. 16 is an enlarged view of FIG. 15 which depicts a contact point embodiment which is engaged with the optical element.

FIG. 17 depicts the low interference optical mount assembly embodiment of FIG. 1 with the addition of guard ring to the embodiment.

FIGS. 18 and 19 show multiple low interference optical mount assembly embodiments (and multiple mounted optical elements) which are secured in tandem to an optical bench.

FIG. 20 is a perspective view of a low interference optical mount embodiment and an optical element which is mounted to the low interference optical mount embodiment.

FIG. 21 is a perspective view of the low interference optical mount embodiment of FIG. 20 with a portion of the optic mount body hidden.

FIG. 22 is a section view of the low interference optical mount embodiment and optical element both of FIG. 20.

FIG. 23 is a perspective view of a low interference optical mount embodiment and an optical element which is mounted to the embodiment.

FIG. 24 is an elevation view of the low interference optical mount embodiment and optical element of FIG. 23.

FIG. 25 is a top view of the low interference optical mount embodiment of FIG. 23.

FIG. 26 is an elevation view in section of the low interference optical mount embodiment and optical element of FIG. 23.

FIG. 27 is a perspective view of a low interference optical mount embodiment and an optical element which is mounted to the optical mount embodiment.

FIG. 28 is a section view of the low interference optical mount embodiment and optical element of FIG. 27.

FIGS. 29 and 30 are elevation views of a schematic representation of an embodiment of a low interference optical mount assembly.

FIG. 31 is a perspective view of a low interference optical mount assembly embodiment.

FIG. 32 is a perspective view of the low interference optical mount assembly embodiment of FIG. 31 with multiple optical elements mounted to the embodiment.

FIGS. 33 and 34 are front and side elevation views of the low interference optical mount assembly embodiment of FIG. 31.

FIG. 35 is an enlarged view of the encircled portion 3 of the embodiment of FIG. 34.

FIG. 36 is a perspective view of a clamp plate embodiment.

FIG. 37 is an elevation view of the clamp plate embodiment of FIG. 37 and multiple optical elements coupled to the clamp plate.

FIG. 37 is an elevation view of the clamp plate embodiment of FIG. 37 and multiple optical elements coupled to the clamp plate.

FIG. 39 is an elevation view of a rotating support frame embodiment.

FIG. 40 is a sectional view of the rotating support frame embodiment of FIG. 39, an optical mount embodiment, and multiple embodiments of a ball detent apparatus.

### DETAILED DESCRIPTION

The embodiments which are discussed herein are generally directed to low interference optical mounts and assemblies thereof which may be used in order to secure optical elements such as lenses, mirrors, filters or the like to an optical surface such as an optical bench of an optical apparatus. The optical elements may then interact with other optical components of the optical apparatus such as lasers, cameras, detectors and the like. The low interference optical mounts may be configured such that optical elements may be quickly and easily coupled to and released from the low interference optical mount. Each optical element generally incorporates at least one useable surface; for an optical element such as a lens the useable surface may be a contoured surface or a chemically treated surface. An optical element such as a mirror may have a useable surface which is configured to be optically reflective, while an optical element such as a filter may have multiple useable surfaces which are generally flat and parallel to each other. In order to securely couple an optical element, low interference optical mount embodiments may utilize multiple surfaces of an optical element as contact points and/or contact surfaces. Some of the contact surfaces may include useable surfaces of the optical element, and the low interference optical mount may be configured to minimize the amount of useable surface of the optical element which is used as a contact surface. In this way the utility of each optical element is increased because the available surface area of the useable surface of each optical element has been maximized while in a mounted state.

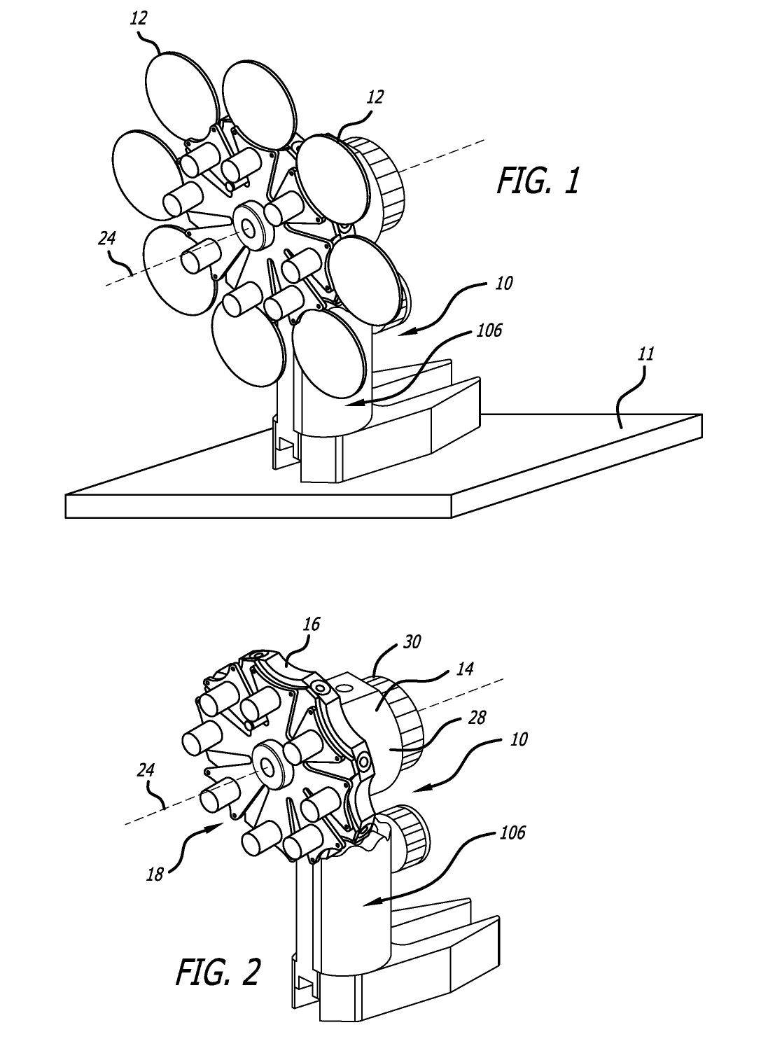

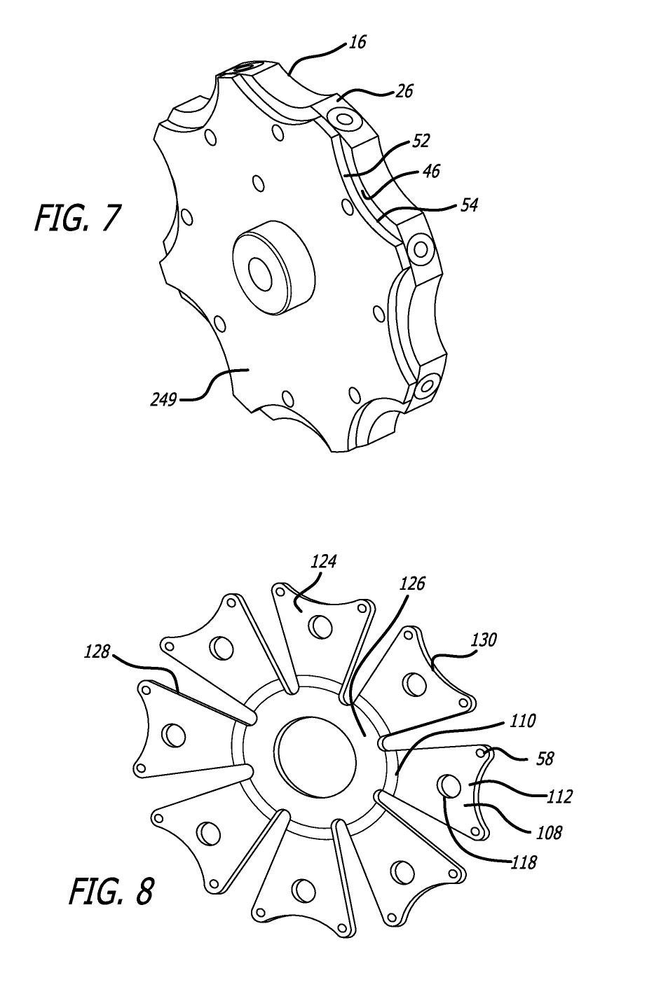

Some embodiments of low profile optical mounts may be configured to mount a single optical element, while other embodiments of low profile optical mounts may be configured to mount multiple optical elements simultaneously. A low interference optical mount assembly 10 that is capable of mounting multiple optical elements 12 simultaneously may include a base member 14, a rotating support frame 16, and multiple optical mounts 18 disposed about an outer portion of the support frame 16 as shown in FIGS. 1 and 2. The low interference optical mount assembly may be mounted on an optical bench 11. The rotating support frame 16 may be configured as a rigid disk (see FIGS. 6 and 7) which may be rotatably coupled to a distal section 20 of the base member 14. In some instances, the rotating support frame 16 may have a somewhat scalloped outer perimeter with an inward dip corresponding to the circumferential location of each optical mount 18 of the system 10. The disk of some embodiments of the support frame 16 may have an outer transverse dimension of about 2.0 inches to about 2.5 inches and a thickness of about 0.2 inches to about 0.3 inches, although many other dimensions may be appropriate depending on the shape and size of optical element 12 to be mounted. The base member 14 may have a generally cylindrical shape in some embodiments.

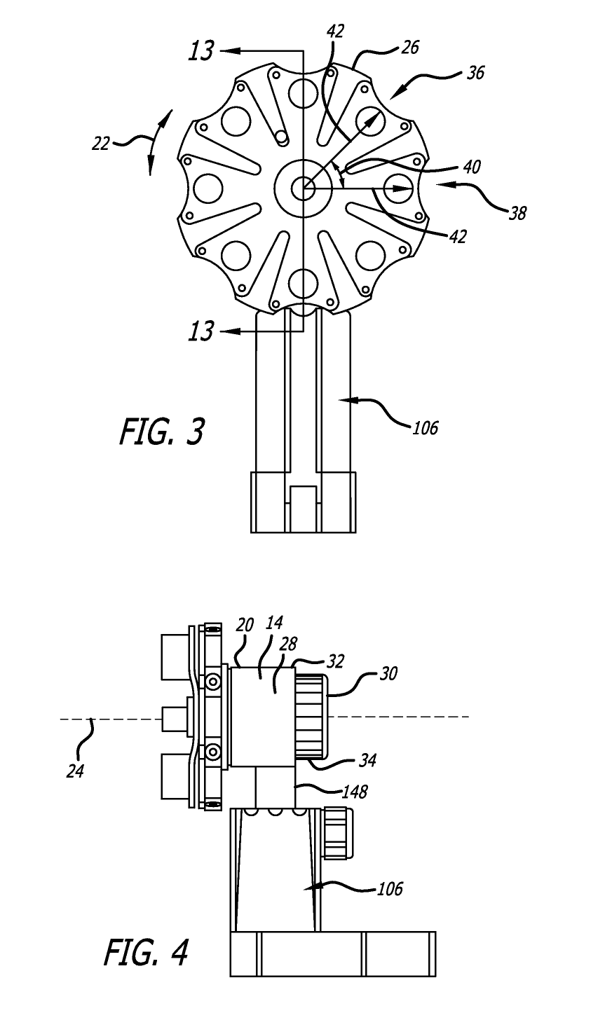

The rotating support frame 16 may rotate (as indicated by arrow 22 in FIG. 3) with respect to the base member 14 about an axis of rotation 24 such that an outer surface 26 of the rotating support frame 16 remains substantially concentric to an outer surface 28 of the base member 14 during the rotation. For some embodiments, the rotatable coupling arrangement between the rotating support frame 16 and the base member 14 may be configured such that the rotating support frame 16 maintains a substantially constant axial position with respect to the base member 14 along the axis of rotation 24 during rotation. A frame adjustment knob 30 may be disposed at a proximal section 32 of the base member 14, with an outer surface 34 of the frame adjustment knob 30 being disposed such that it is concentric with the outer surface 28 of the base member 14. The frame adjustment knob 30 may be operatively coupled to the rotating support frame 16 such that rotating the frame adjustment knob 30 results in the rotation of the rotating support frame 16 about the axis of rotation 24.

The low interference optical mount assembly 10 may be configured to allow for multiple optical elements 12 to be coupled to the rotating support frame 16. To this end, a plurality of optical mounts 18 may be disposed about the rotating support frame 16, with each optical mount 18 being configured to releasably secure to an optical element 12 thereto. The low interference optical mount assembly embodiment 10 shown in FIG. 3 may include a first optical mount 36 and a second optical mount 38, both of which are rigidly disposed on the rotating support frame 16. Each optical mount 18 may be circumferentially disposed about the axis of rotation 24 at a common radial distance from the axis of rotation 24. The angular circumferential separation between each adjacent optical mount 18 may vary for different embodiments of the low interference optical mount assembly 10 depending on the number of optical mounts 18 which are disposed about the rotating support frame 16. For the embodiment shown in FIG. 3, the first optical mount 36 is separated from the second optical mount 38 by an angular circumferential separation 40 of about 45 degrees as indicated in FIG. 3. For a given embodiment of a low interference optical mount assembly 10 with a given number of optical mounts 18, the totality of optical mounts 18 may be configured such that the angular circumferential separation 40 between each adjacent optical mount 18 is substantially equal. For example, if an embodiment of a low interference optical mount assembly 10 has four optical mounts 18, the optical mounts 18 may be configured such that angular circumferential separation 40 between each adjacent optical mount 18 is about 90 degrees.

As the rotating support frame 16 is rotated with respect to the base member 14 about the axis of rotation 24, it rotates any optical elements 12 secured to the optical mounts 18 thereof about the axis of rotation 24. As such, any optical element 12 which is mounted to the low interference optical mount assembly 10 may be selectively positioned so as to interact with an optical component of an optical apparatus. For example, an optical element 12 such as a first filter which is mounted to the low interference optical mount 10 may be positioned such that it interacts with an optical beam of a laser of the optical apparatus. Rotation of the rotating support frame 16 may then rotate a second filter into the position which was occupied by the first filter such that the second filter interacts with the beam of the laser. Another rotation of the rotating support frame may rotate a third filter into the position which was occupied by the second filter such that the third filter interacts with the laser and so on. Each optical element 12 which is mounted to a respective optical mount 18 may therefore interact with a given optical component of the optical apparatus.

The radial distance from the axis of rotation 24 to each optical element 12 (which is mounted to a respective optical mount 18) may be substantially equal in order for each optical element 12 to be properly positioned with respect to the optical component after a rotation 22 of the rotating support frame 16. FIG. 3 depicts the first optical mount 36 and the second optical mount 38 which are disposed on the rotating support frame 16 at an angular circumferential separation 40 of about 45 degrees. As discussed above, the first optic mount 36 and the second optic mount 38 are disposed at a common radius 42 from the axis of rotation 24. The additional optic mounts 18 are also radially disposed in a fixed relation at the same common radius 42 from the axis of rotation 24. In some cases, it may be useful to use the radial position of an optic stop 52, discussed below, to determine the common radius position of each optical mount 18 and optical element 12 mounted therein. In this manner each optical element 12 which is mounted to an optical mount 18 of the low interference optic mount assembly 10 may exchange positions with any other optical element 12 after sufficient rotation of the rotating support frame 16 through the angular circumferential separation 40.

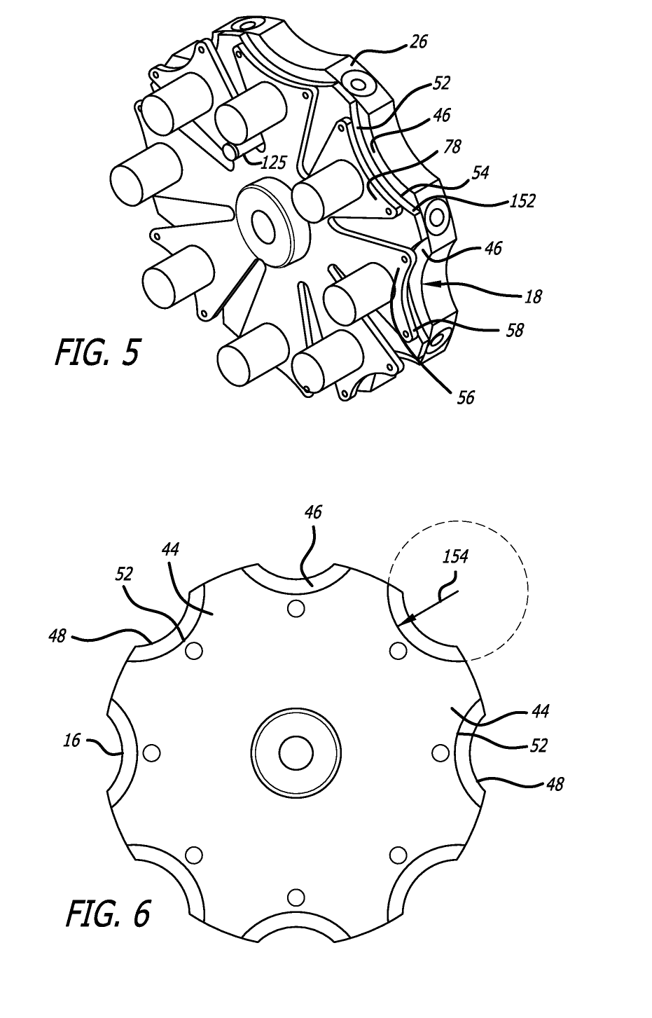

Each optic mount 18 may be configured to releasably and controllably clamp an optical element 12 to the low interference optical mount assembly 10. Any suitable optical element 12 may be mounted, however, the optical mount assembly embodiments 10 discussed herein are generally used to mount optical elements 12 having flat parallel opposed useable surfaces, including filters, mirrors, windows and the like. Some embodiments of such optical elements 12 may have an outer peripheral shape that is round, rectangular, square or any other suitable shape. Each optic mount 18 may include an optic mount body 44 which in turn may include a datum surface 46 which is disposed along an outer radial edge 48 of the optic mount body 44 as shown in FIGS. 5 and 6. The datum surface 46 lies in a plane which is perpendicular to the axis of rotation 24 of the rotating support frame 16. The datum surface 46 may be configured to contact a partial outer edge 50 of an optical element 12 and leave a majority of a perimeter of the optical element 12 free of contact. The optic mount body 44 may also incorporate an optic stop structure 52 which extends from the plane of the datum surface 46 and which is disposed in fixed relation to the datum surface 46. The optic stop structure 52 may bound an inner radial boundary 54 of the datum surface 46 and may provide a surface against which the outer edge 50 of an optical element 12 which is to be mounted can make contact.

An optical element 12 may be releasably and controllably secured to the optical mount 18 by a clamp which is configured as a leaf spring clamp assembly 56 (see FIG. 5). The leaf spring clamp assembly 56 may include at least one contact point 58 which is disposed in opposition to the datum surface 46. The leaf spring clamp assembly 56 may be moveable relative to the datum surface 46 in a direction which is generally perpendicular to the datum surface 46, and the leaf spring clamp assembly 56 may be configured to releasably and controllably clamp an optical element 12 between the at least one contact point 58 and the datum surface 46. The datum surface 46, optic stop structure 52, and leaf spring clamp assembly 56 may all be configured to releasably and controllably clamp an optical element 12 to the optic mount 18 with minimal optical interference of the useable surface(s) of the optical element(s) 12. An optical element 12 which is mounted to the optical mount may be disposed such that an outer surface 60 or edge of the optical element 12 is in contact with the optic stop structure 52. A first useable surface 62 of the optical element 12 may contact the datum surface 46, and a second useable surface 64 of the optical element 12 may be contacted by the contact points 58 of the leaf spring clamp assembly 56 on the opposite side of the optical element 12.

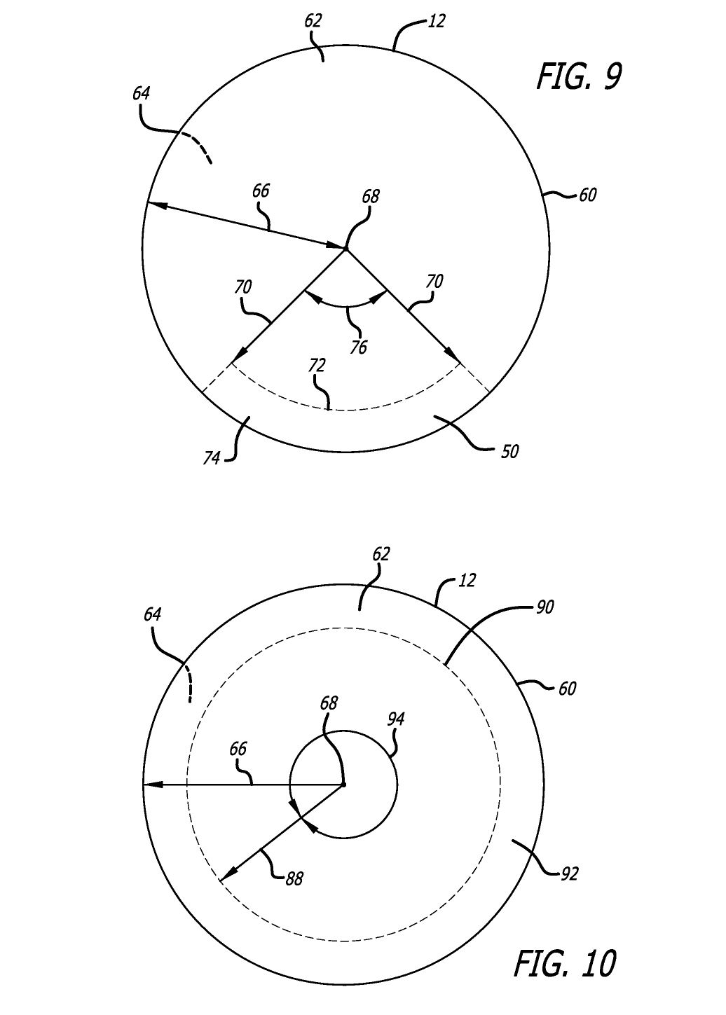

The optical element 12 which is depicted in FIG. 9 is used to illustrate the portion of the useable surface(s) of the optical element 12 which the optical mount 18 optically interferes with in some cases. The optical element 12 has a radius 66 which extends from a center axis 68 of the optical element to the outer edge 60 of the optical element 12. The radius 66 spans the area of the first useable surface 62 of the optical element 12. A mount radius 70 extends from the center axis 68 of the optical element 12 to an inner radial boundary 72 of a mount area 74 which is the area of the first useable surface 62 of the optical element 12 which the optical mount 18 optically interferes with. The circumferential extent of the mount area 74 is indicated by a mount angle 76 which determines the percentage of the perimeter of the first useable surface 62 which the optical mount 18 optically interferes with. In general, the second useable surface 64 (which is disposed opposite the first useable surface) will have a mount area which is disposed substantially similar to the mount area 74 of the first useable surface 62.

In some cases, the mount area 74 of the optical element 12 may be determined by the area of the datum surface 46 of the optic mount body 44 and by a corresponding clamp mount area 78 of the leaf spring clamp assembly 56. The clamp mount area 78 is an area of the leaf spring clamp assembly 56 which surrounds the contact points 58 and which may have an outer profile which is configured to conform generally to the contours of the datum surface 46. In order to minimize the percentage of useable surface of the optical element 12 which is optically interfered with by the optical mount 18, the area of the datum surface 46 and the corresponding clamp mount area 78 can be minimized while still providing a secure grip to the optical element 12. That is to say that the mount radius 70 and mount angle 76 can be adjusted to a minimum value while still maintaining enough of each area to safely secure to the optical element 12 to the optical mount 18. As can be seen in FIG. 9, the mount area 74 which is used by the optical mount 18 in order to secure the optical element 12 only occupies a small portion or percentage of the first useable surface 62 (the mount area 74 generally conforms to the contours of the datum surface 46).

As discussed above, each datum surface 46 is configured to contact an outer edge 50 of an optical element 12 and leave a majority of a perimeter portion of the useable surfaces of the optical element 12 free of contact or optical interference from the datum surface 46. To this end, a datum surface 46 may generally be configured to have a surface area that is less than about 15 percent of a usable surface area of the optical element 12 which is to be mounted in each respective optic mount 18. In some cases the datum surface 46 may be configured and sized to have a surface area that is from about 5 percent to about 20 percent of a usable surface area of the optical element 12 which is to be mounted in each respective optic mount 18, in some instances, about 5 percent to about 10 percent. Additionally, the mount angle 76 of the datum surface 46 may be from about 25 degrees to about 100 degrees in some cases. In some embodiments, the maximum inward radial incursion of the mount area 74 of a given datum surface 46 may be minimized in order to keep a center portion of the usable area of an optical element 12 free of optical interference. As such, in some cases, the ratio of the length of the mount radius 70 line that extends from the center axis 68 of an optical element 12 to an inner boundary 72 of the mount area 74 with respect to the length of a radius 66 line that extends to an outer edge 60 of the optical element 12 may be at least about 70 percent, in some cases about 75 percent to about 90 percent.

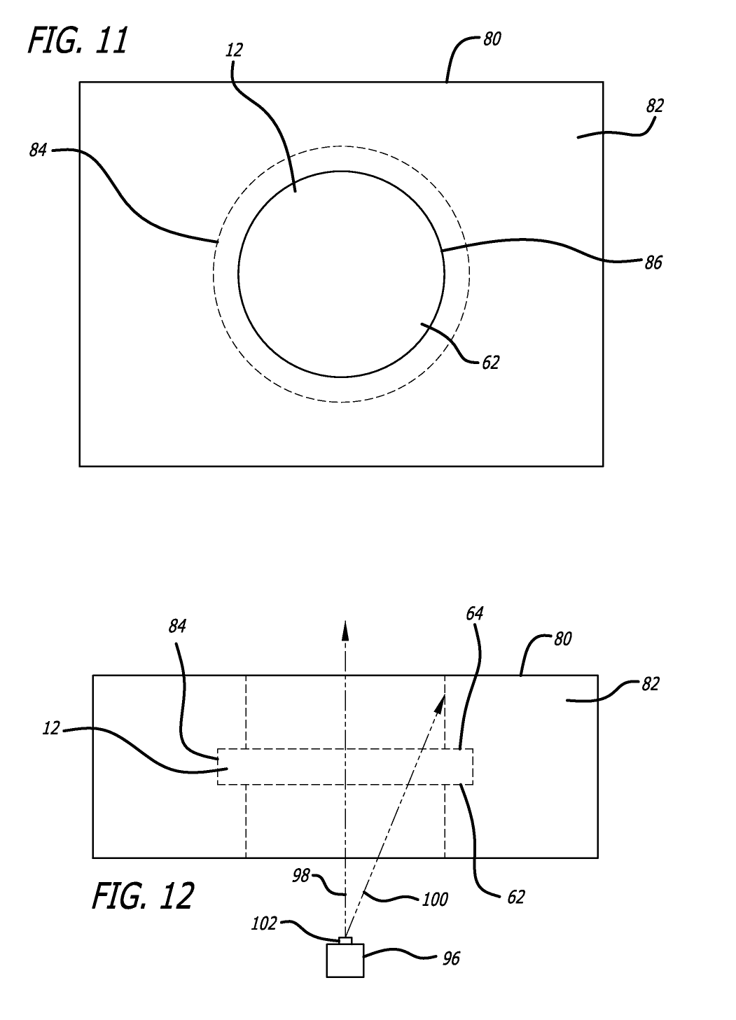

This can be contrasted with commercially available optical mount configurations which use a much larger percentage (up to 25% or more) of the useable surface of the optical element 12 in order to secure the optical element to commercially available optical mounts. FIGS. 10-12 illustrate the percentage of useable surface of an optical element 12 which is optically interfered with by a commercially available optical mount 80. FIG. 10 depicts an optical element 12 which includes a first useable surface 62, a second useable surface 64 which is parallel to and opposed to the first useable surface 62, and an outer surface 60 that may also be referred to as a perimeter edge of the optical element 12. The optical element 12 can be mounted onto a commercially available optical mount 80 which has an optic mount body 82 and which is shown schematically in FIGS. 11 and 12. This commercially available optical mount 80 incorporates an optical recess 84 which is disposed within the optic mount body 82 and which is configured to capture the optical element 12. The commercially available optical mount 80 also incorporates multiple windows 86 which expose portions of the first useable surface 62 and the second useable surface 64 of the optical element 12. In this case, the material surrounding the windows 86 of the commercially available optical mount 80 optically interferes with the entire perimeter of the useable surfaces of the optical element 12. This is illustrated in FIG. 10 which depicts a radius line 66 which extends from a center axis 68 of the optical element 12 to the outer edge of the optical element. The radius line 66 spans the area of the first useable surface 62 of the optical element 12. A mount radius line 88 extends from the center axis 68 of the optical element 12 to an inner radial boundary 90 of a mount area 92 which is the area of the first useable surface 62 which is optically interfered with by the commercially available optical mount 80. The circumferential portion of the mount area 92 is indicated by a mount angle 94 which in this case spans the entire perimeter of the first useable surface 62 of the optical element 12 (compare this to mount angle 76 in FIG. 9 for certain optical mount embodiments discussed herein). In general, the second useable surface 64 (which is disposed opposite the first useable surface 62 of the optical element 12) will have a mount area which substantially corresponds to the mount area 92 of the first useable surface 62.

Some commercially available optical mounts 80 may be configured such their mount areas 92 interfere with up to about 25% of the useable surfaces of an optical element 12. Additionally, some commercially available optical mount configurations may limit the acceptance angle of an optical element 12 which is mounted to such an optical mount 80. FIG. 12 depicts a commercially available optical mount 80, the optical element 12 which is mounted in the optical recess 84 of the optical mount 12, and an optical source 96 (such as a laser). The optical source 96 is shown emitting a first output beam 98 and a second output beam 100 from a lens 102 of the optical source 96. The first output beam 98 from the optical source 96 exits the optical source 96 such that it is substantially perpendicular to the lens 102 of the optical source 96. The first output beam 98 passes through the first useable surface 62 and through the second useable surface 64 and exits the optical mount 80 without optical interference. The second output beam 100 from the optical source 96 exits the lens 102 of the optical source 96 obliquely. The second output beam 100 passes through the first useable surface 62 and the second useable surface 64 of the optical element 12 but is optically interfered with by the optical mount body 82 of the commercially available optical mount 80. The width of the commercially available optical mount 80 can thus be a limitation with regard to the acceptance angle of an optical element 12 which is mounted in such an optical mount 80. As such, optical mount embodiments that are discussed herein which mount optical elements 12 with the edges free of interference provide a far greater useable area which is available for interaction with light beams of an optical apparatus.

The leaf spring clamp assembly 56 of optical mount embodiments discussed herein may be configured to releasably and controllably clamp an optical element 12 to the optical mount 18. The leaf spring clamp assembly 56 of the optical mount 18 may be configured in a variety of different ways. The embodiment of the low interference optical mount assembly 10 incorporates multiple clamps which may be configured as leaf spring clamp assemblies 56. The low interference optical mount assembly 10 may include an optical post assembly 106, the base member 14, the rotating support frame 16 (see FIGS. 6 & 7), and multiple optical mounts 18 which are circumferentially disposed on the rotating support frame 16 at the common radius 42 from the axis of rotation 24. Each optical mount 18 may include an optic mount body 44 which may incorporate the datum surface 46 and the optic stop structure 52.

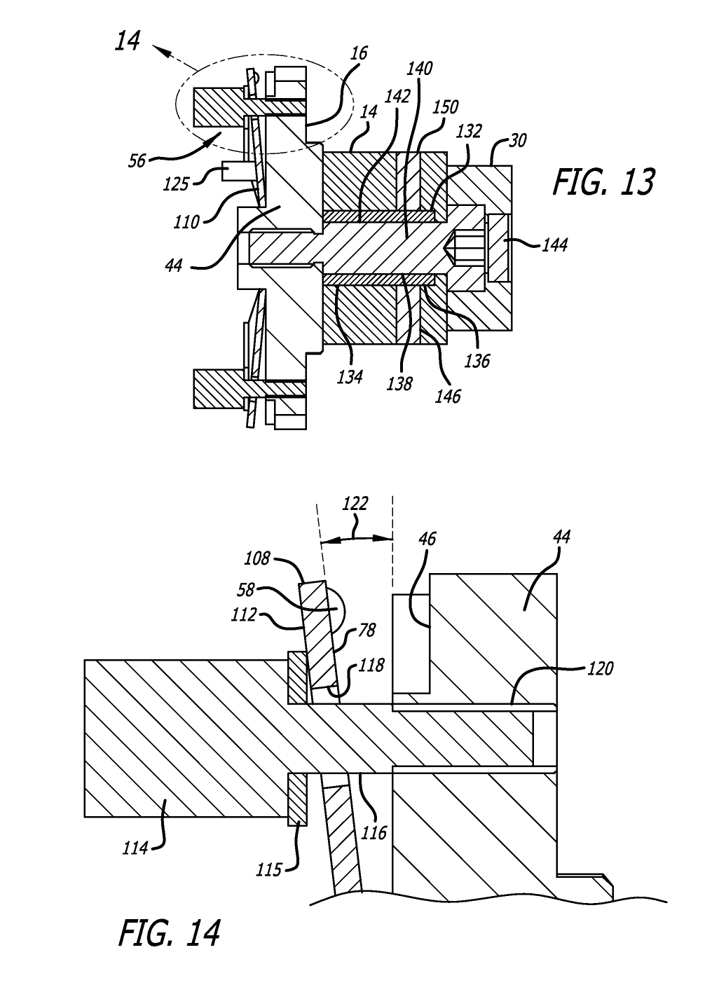

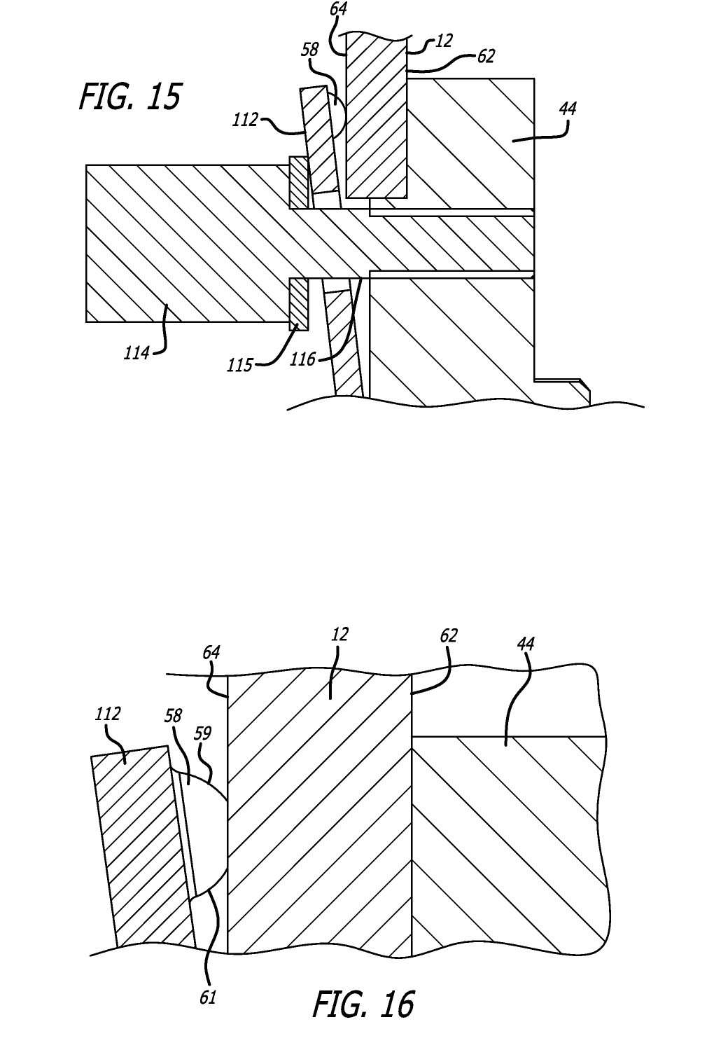

The leaf spring clamp assembly 56 may include a resilient leaf spring 108 which has an inner radial portion 110 which may be secured in a fixed relation relative to the optic mount body 44 as shown in FIG. 13. Each resilient leaf spring 108 may also have an outer radial portion 112 which comprises at least one contact point 58 which is disposed in opposition to the datum surface 46. Each resilient leaf spring 108 may be configured such that it is resiliently moveable relative to the datum surface 46. The leaf spring clamp assembly 56 may also include a clamp screw 114 which has a threaded shaft 116 that passes through a clearance hole 118 in the leaf spring 108, and which is threadedly engaged with a mating threaded hole 120 in the optic mount body 44. Tightening the clamp screw 114 overcomes a resilient spring resistance of the leaf spring 108 and forces the outer radial portion 112 of the leaf spring 108 closer to the datum surface 46 in order to releasably clamp an optical element 12 between at least one contact point 58 and the datum surface 46 (see FIG. 15). A clamp screw washer 115 may optionally be disposed between the clamp screw 114 and the outer radial portion of the leaf spring 112. In some cases, the optional clamp screw washer may be made from a polymer material such as Nylon® or any other suitable material.

The separation between the contact point 58 and the datum surface 46 may be configured to be greater than a width of the optical element 12 between the useable surfaces 62 and 64 when the clamp screw 114 is loose and the resilient leaf spring 108 is in a relaxed uncompressed state as shown in FIG. 14. As shown in FIG. 16, a surface 59 of each contact point 58 may deform when it contacts the optical element 12. The deformation of the contact point 58 may increase the adhesion of the contact point 58 to the second useable surface 64 of the optical element 12, and may also prevent damage to the second useable surface 64 of the optical element 12 by the contact point 58.

The resilient leaf spring 108 may be fabricated from any suitable high strength resilient material having the ability to be deformed into a deformed configuration and elastically return to an un-deformed configuration. Suitable materials for the resilient leaf spring 108 may include spring steel, composite materials and the like. For some configurations of the low interference optical mount assembly 10, the optic mount body 44, the resilient leaf spring 108, and the clamp screw 114 may be configured to provide about 1 mm to about 10 mm of relative adjustable separation between the datum surface 46 and the contact points 58. This allows for optical elements 12 with widths between 1 mm to 10 mm to be inserted between the datum surface 46 and the contact points 58 without interference. For some embodiments, the outer radial portion 112 of each resilient leaf spring 108 forms a preset angle 122 of about 8 degrees to about 12 degrees with respect to the plane of the datum surface 46 when the resilient leaf spring 108 is in a relaxed uncompressed state as shown in FIG. 14.

For the embodiment of the low interference optical mount assembly shown 10, the resilient leaf springs 108 may all be included in a monolithic leaf spring member 124 as shown in FIG. 8. The monolithic leaf spring member 124 can be formed from a single piece of thin resilient material with the inner radial portion 110 of each resilient leaf spring 108 extending from a central hub 126 of the monolithic leaf spring member 124. Adjacent resilient leaf springs 108 may be separated by a radially oriented slot 128 that extends from the hub 126 to an outer radial edge 130 of the monolithic leaf spring member 124 so as to permit substantially independent compression of each resilient leaf spring 108 of the monolithic leaf spring member 124. The leaf springs 108 of the monolithic leaf spring member 124 may be configured such that they are all the same size and have the same resilient resistance to compression by the respective clamp screws 114. The inner radial portion 110 of each resilient leaf spring 108 may be secured in fixed relation to the optic mount body 82 by a compression force which is exerted by the clamp screws 114 of each of the other resilient leaf springs 108 as shown in FIG. 5. The angular orientation of the monolithic leaf spring member 124 may be fixed or otherwise limited by a pin 125 that is secured to and extending from a front surface of the support frame 16. The pin 125 may be disposed in one of the radially oriented slots 128 as shown.

The leaf spring clamp assembly 56 can be manually activated without the need for tools in order to insert an optical element 12 into a given optical mount 18. Each optic mount body 44 may be integrally formed into the rotating support frame 16 as shown in FIGS. 6 and 7. The rotating support frame 16 may be formed monolithically from a single piece of material. The material of the monolithically formed support frame 16 may be a lightweight rigid material such as aluminum. Other suitable materials for the support frame 16, base member 14 or certain other components of the system 10 may include rigid, stable, high strength materials such as metal alloys including stainless steel, composite materials, ceramic materials and the like. For some embodiments, the low interference optical mount assembly 10 can include about two optical mounts 18 to about ten optical mounts 18 which may be evenly spaced about the circumference of the rotating support frame 16. In some cases the low interference optical mount assembly 10 may be configured such that the multiple optical mounts 18 which are evenly spaced about the circumference of the rotating support frame 16 include an angular circumferential separation 40 that provides a compact device overall yet still allows for the manual mounting and removal of optical elements 12 from all of the optical mounts 18 while gripping the optical elements 18 from the edges. Some embodiments of the low interference optical mount assembly 10 may be configured with 8 optical mounts 18 which are each configured to mount an optical element 12 having an outer diameter of about 1 inch, which each have an angular circumferential separation 40 of about 45 degrees, and which each have an optic stop structure 52 disposed at a radial distance from the axis of rotation 24 of about 20 mm to about 30 mm.

For some embodiments, the leaf spring clamp assembly 56 may include from one to three contact point embodiments 58. Each contact point embodiment 58 may be formed from a resilient polymer material which may be configured such that it is softer than a material of an optical element 12 which is to be mounted using the contact point embodiment 58. This resilient polymer which is softer than a material of an optical element 12 to be mounted may be sufficient to distribute the clamping force of the contact point 58 and prevent pressure points that may crack or otherwise damage the material of an optical element 12. The elastic deformation and clamping force distribution is illustrated in FIG. 16. For some embodiments the contact points 58 may be formed from nylon, polytetrafluoroethylenes such as Teflon® and the like. For other embodiments the contact points 58 may be formed by stamping a protrusion into a thin resilient material of the resilient leaf spring 108 and coating the contact point 58 with a resilient polymer material. The coating 61 of the contact point 58 may be applied by dipping, spraying, vapor deposition methods and the like. In some cases, the polymer coating of each contact point 58 may have a thickness of about 0.00005 inches to about 0.003 inches, more specifically, about 0.0005 inches to about 0.003 inches, even more specifically, about 0.0005 inches to about 0.001 inches. The same coating 61 that is applied to the contact point 58 may also be used to coat additional portions of the resilient leaf spring 108 including an entire surface of both sides of the resilient leaf spring 108. Such a coating of other portions of the resilient leaf spring 108 may be useful for providing a dark or black non-reflective surface that minimizes or prevents undesirable beam reflection.

As has been discussed previously, the rotating support frame 16 may be coupled to the base member 14 such that the rotating support frame 16 can rotate about the axis of rotation 24 with respect to the base member 14. FIG. 13 is a sectional view of the rotating support frame 16, the base member 14, and the frame rotation knob 30. A lubricious bushing 132 may be disposed on a cylindrically shaped interior surface of the base member 14. The bushing 132 may be secured to an inside surface 134 of a bore 136 of the base member 14. The bushing 132 may include a cylindrical bore 138 that extends coaxially with the axis of rotation 24. A rotating shaft 140 of the rotating support frame 16 may have an outer cylindrical surface 142 that is configured to have a close fit with the cylindrical bore 130 of the bushing 132 which facilitates accurate rotation of the shaft 140 and rotating support frame 16 about the axis of rotation 24. For some embodiments the lubricious bushing 132 may be fabricated from nylon. The frame rotation knob may be secured to the shaft by a fastener 144. As such, rotation of the frame rotation knob 30 rotates the cylindrical surface 142 of the shaft 140 which spins freely within the inner bore 138 of the lubricious bushing 132. This rotation of the frame rotation knob 30 in turn rotates the rotating support frame 16 which is rigidly secured to the shaft 140.

The interface between the rotating support frame 16 and the base member 14 may be configured such that the rotating support frame 16 can be manually rotated without the use of tools relative to the base member 14. The rotation of the rotating support frame 16 can further be carried out in an indexed manner wherein the indexing may be configured to match a circumferential spacing 40 of the plurality of optical mounts 18 disposed about the rotating support frame 16. The same indexed configuration may be used for any rotating mount assembly embodiment discussed herein.

In some cases, the indexed interface between the rotating support frame 16 and the base member 14 or the corresponding components of any other rotating mount assembly embodiments herein may include at least one ball detent apparatus 268 with an angular circumferential detent spacing 270 which is configured to match an angular circumferential spacing 40 of the plurality of low interference optic mounts 18. Each ball detent apparatus 268 may include a spherical ball 274, a ball spring 276, a spring channel 278 which is disposed within a base member body 280, and at least one detent 282 which is disposed on a back surface 284 of the rotating support frame 16. The spherical ball 274 and ball spring 276 may be configured within the spring channel 278 such that the ball is disposed near a distal end 286 of the spring channel 278 as shown in FIG. 40, which is a sectional view of the rotating support frame 16, the base member 14, and multiple ball detent apparatus embodiments 268. Each ball spring 276 provides a restorative force 288 on each spherical ball 274, with each restorative force 288 being directed parallel to the axis of rotation 24 and toward the back surface 284 of the rotating support frame 16.

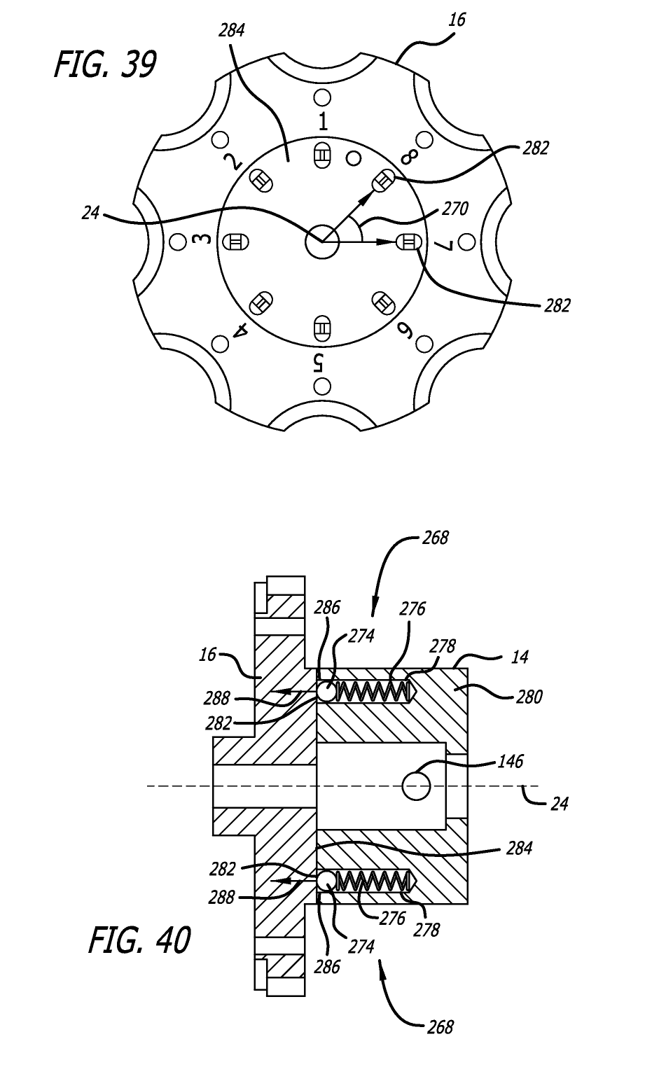

The back surface 284 of the rotating support frame 16 may be configured with a circular array of detents 282 as is shown in FIG. 39. The angular circumferential detent spacing 270 (angular spacing between adjacent detents 282) may be configured to match an angular circumferential spacing 40 of the plurality of low interference optic mounts 18 (see FIG. 3). For the ball detent apparatus embodiments 268 shown in FIG. 40, each ball spring 276 may apply a respective restorative force 288 to each respective spherical ball 274. Each restorative force 288 causes each spherical ball to apply pressure to its respective detent 282 thereby preventing angular rotation (with respect to the axis of rotation 24) of the rotating support frame 16 with respect to the base member 14. The rotating support plate 16 may then be rotated about the axis of rotation 24 to a new angular position wherein each spherical ball 274 engages with a new respective detent 282. The use of the ball detent apparatus 268 thus allows for the indexed rotation of the rotating support frame 16 with respect to the base member 14, with the detent 282 positions on the rotating support frame corresponding to the positions of the optical mounts 18 which are also disposed on the rotating support frame 16. Each detent 282 position may be labeled with a number as shown in FIG. 39, with each number allowing for a user of the low interference optical mount assembly 10 to place different optical element configurations in each optical mount 18, and to then track the position of each optical element configuration using the numbers. It may also be useful in some embodiments of the system 10 discussed herein that an amount of torque required to dislodge an engaged ball detent apparatus 268 between the support frame 16 and the base member 14 be greater than an amount of torque required to turn one of the clamp screws 114. In such a case, the clamp screws 114 can be adjusted in order to mount or remove an optical element 12 to or from the respective optical mount 18 thereof without dislodging the angular position of the support frame 16.

The base member 14 may include at least one post mount interface 146 (see FIG. 13) which is configured to mount to an optical post 148 of the optical post assembly 106. The post mount interface 146 may be configured as a threaded hole which is configured to couple to a threaded extension of the optical post 148. Some embodiments of the base member 14 may include multiple threaded holes 148 which are configured to couple to multiple threaded extensions of different optical posts 148. For example, the base member 14 may have a first threaded hole 148 which is tapped with an M4 thread, and a second threaded hole 150 which is tapped as an 8-32 thread. As discussed above, the base member 14 may be formed from a lightweight rigid material such as aluminum or other suitable materials.

Each optic mount body 44 may include an optic stop structure 52. Each optic stop structure embodiment 52 may be formed as a ridge that extends above the plane of its respective datum surface 44 as shown in FIG. 5. The ridge forms a surface 152 that faces generally radially outward from the axis of rotation 24. In addition the surface contour of the ridge is generally circular. The radius 154 of the circular contour of the ridge (see FIG. 6) may be from about 0.25 inches to about 1 inch.

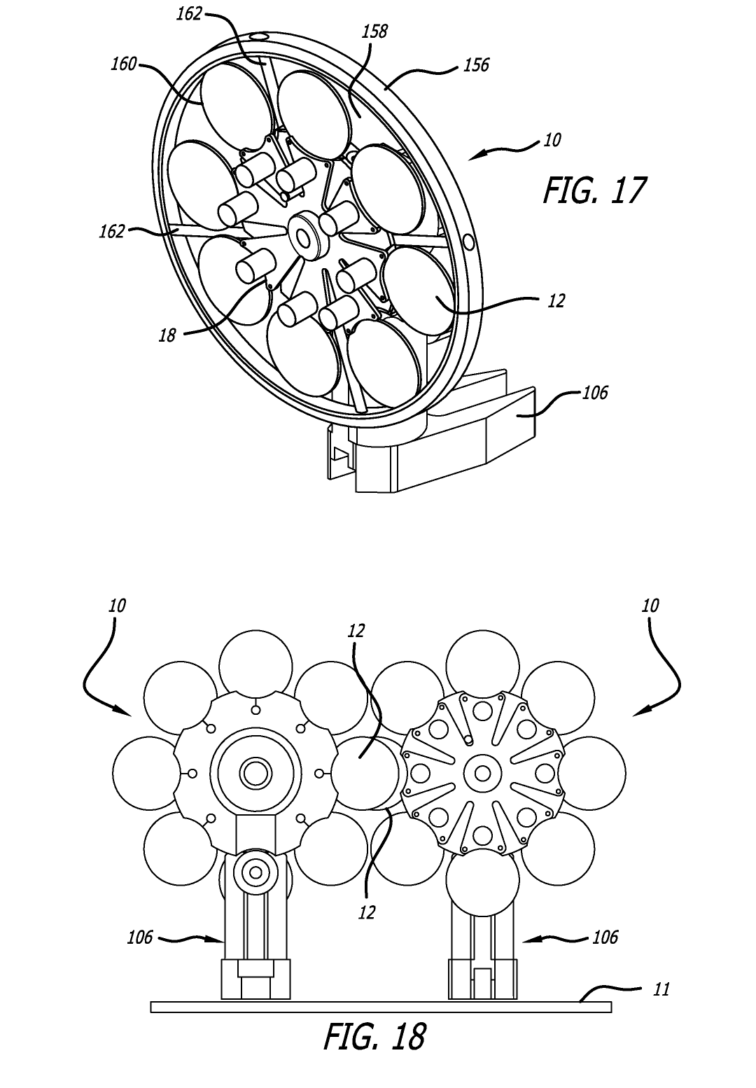

The low profile optical mount assembly embodiment 10 may optionally include an outer guard ring 156 which is shown in FIG. 17. The outer guard ring 156 may be configured to protect the multiple optical elements 12 which are secured to the low interference optical mount assembly 10 by providing a rigid protective ring around the multiple optical elements 12. The outer guard ring 156 may have an aperture 158 with a transverse dimension which is sized to clear an outer radial edge 160 of all of the optical elements 12 which are mounted in their respective optic mounts 18. Further, the outer guard ring 156 may be secured to the rotating support frame 16 by one or more radial extension members 162 that are sized to fit between optical elements 12 which are mounted in the optical mounts 18.

Multiple low profile optical mount assembly embodiments 10 may be configured such that they can operate in tandem on an optical bench 11 or other suitable work surface. FIGS. 18 and 19 depict two separate embodiments of the low interference optical mount assembly 10. The low interference optical mount assemblies 10 are arranged on the optical bench 11 such that two optical elements 12 (one from each of the low profile optical mount assemblies 10) are in optical alignment. This configuration of the low profile optical mount assemblies 10 is useful for optically combining multiple optical elements 12. For the arrangement shown in FIGS. 18 and 19, the two low interference optical mount assemblies 10 are positioned such that one optical element 12 from each assembly can completely overlap each other by a full diameter of one of the optical elements 12. In this configuration, a center axis 68 of the overlapped optical elements 12 may be aligned such that a light beam perpendicular to the usable surface of either optical element 12 will pass through both aligned optical elements 12. A user may select which optical elements 12 of either assembly to use by rotating the respective frame rotation knob 30 of either assembly. For the arrangement shown, the two low profile optical mount assemblies 10 are facing opposite directions to allow respective overlapped optical elements 12 thereof to be in close proximity.

For some particular embodiments of the low interference optical mount assembly 10, the support frame 16 may be configured with 8 optical mounts 18 disposed about an outer portion of the support frame 16 with a circumferential angular spacing of about 42 degrees to about 48 degrees, more specifically, about 45 degrees. The optic stops 52 of each optical mount 18 may be disposed at a common radius 42 from the axis of rotation 24 of about 0.9 inches to about 0.93 inches. The optic stop surfaces 52 may have a circular contour with a radius of about 0.5 inches which is configured to accommodate a round optical element 12 having flat parallel surfaces, the optical element 12 also having an outer diameter of about 1 inch. The optic stop surfaces 52 in some cases may extend from the datum surface 46 by distance of about 0.04 inches to about 0.08 inches, more specifically, about 0.05 inches to about 0.07 inches. In some embodiments, it may be useful for the distance that the optic stop surface 52 extends from the datum surface 46 to be less than a thickness of the optical element 12 to be mounted. This relationship may provide the necessary clearance for the clamp to secure the optical element 12 to the datum surface 46. An outer transverse dimension of the support frame 16 may be about 2.0 inches to about 2.5 inches and a thickness of about 0.23 inches to about 0.27 inches. The datum surface 46 of each optical mount 18 may be configured to have an area that is about 5 percent to about 10 percent of a useable area of the optical element 12, more specifically, the datum surface 46 may have an area that is about 7 percent to about 8 percent of the useable area of the optical element 12. In some cases, the datum surface 46 may have a surface area of about 0.06 square inches to about 0.062 square inches. In addition, the datum surface 46 may be configured to engage the 1 inch diameter optical element such that the mount angle 76 is about 80 degrees to about 90 degrees, more specifically, about 83 degrees to about 87 degrees. Also, the ratio of the length of the mount radius 70 to the radius line 66 of the optical element 12 may be about 0.8 to about 0.82. For such embodiments, the radial distance from the axis of rotation 24 to the mating threaded hole 120 for the clamp screw 114 of each optical mount 18 may be about 0.8 inches to about 0.9 inches. The radial intrusion of the datum surface 46 into the useable surface 62 of the optical element 12 over the angular extent of the datum surface along mount angle 76 for such embodiments may be about 0.9 inches to about 0.92 inches. This dimension also corresponds to the substantially constant radial extension of the datum surface from the optic stop structure 52 towards the center axis 68 of the optical element 12 along the optic stop structure 52. It should be noted that the dimensions and ranges discussed above with regard to these particular embodiments which are configured to mount an optical element 12 having a 1 inch diameter, may also be scaled so as to be suitable for mounting optical elements 12 of other diameter sizes. For example, in order to accommodate an optical element 12 having a 2 inch diameter, it may be suitable to double the size values of some or all of the dimensions and ranges discussed above in the context of the low interference optical mount assembly 10 which is configured to accommodate the 1 inch diameter optical element 12. Some or all of the angular values and ratios would remain constant for such scaling. Furthermore, one may also suitably extrapolate or interpolate these dimensions and ranges in order to accommodate any other size of optical element 12.

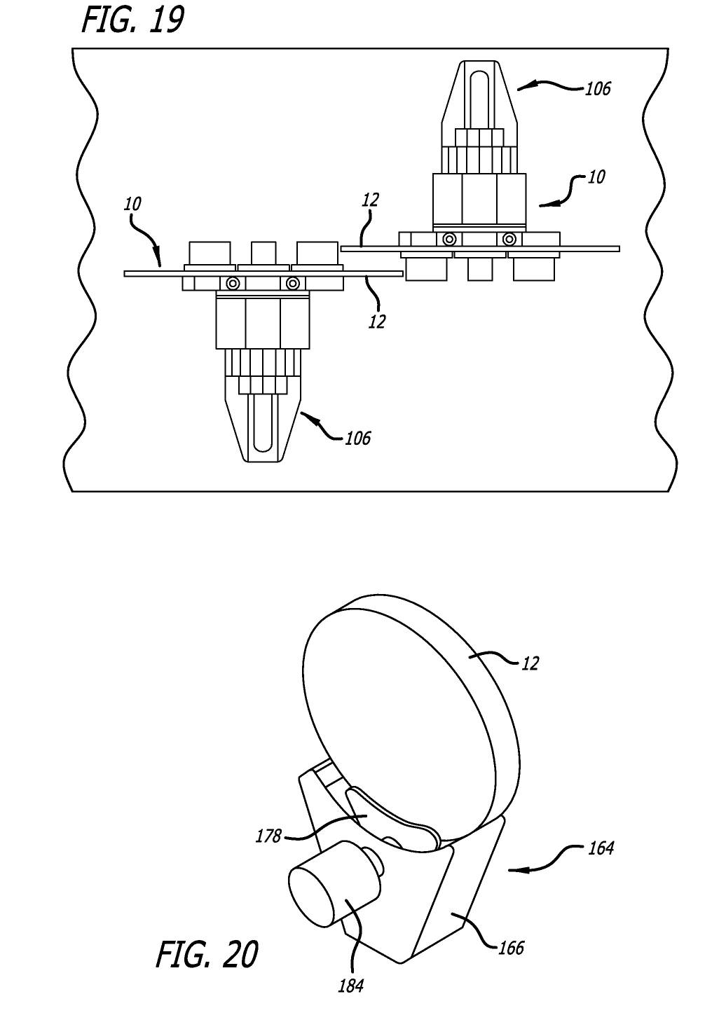

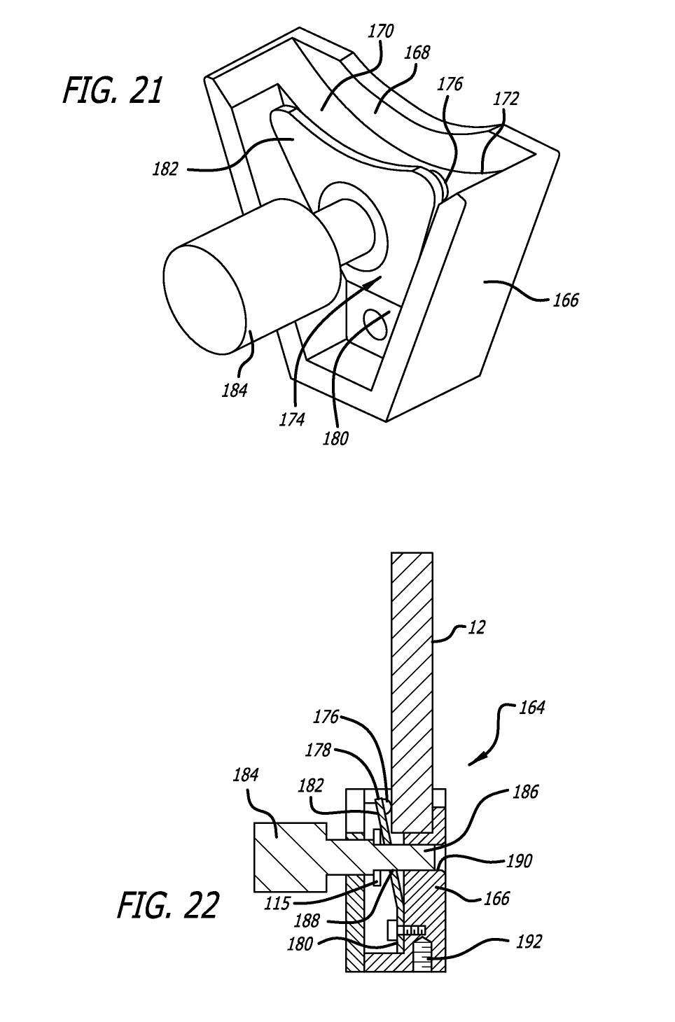

Optical mounts 18 may also be configured such that they mount a single optical element 12. FIGS. 20-22 depict an embodiment of a low profile single optical mount 164 which utilizes the leaf spring clamp configuration of the low interference optical mount assembly 10. The low profile single optical mount 164 may incorporate an optic mount body 166. The optic mount body 166 may include a datum surface 168 which is disposed along an outer edge of the optic mount body 166 and which is configured to contact a partial outer surface of an optical element 12 and leave a majority of a perimeter of an optical element 12 free of contact. The optic mount body 166 may also include an optic stop structure 170 which extends from the plane of the datum surface 168 and which is disposed in fixed relation to the datum surface 168. The optic stop structure 170 may bound an inner boundary 172 of the datum surface 168 and may provide a surface against which an outer edge 50 of an optical element 12 to be mounted makes contact. The optic stop structure 170 which provides a physical stop for optical elements 12 may be configured as an arc shaped ridge which extends above the plane of the datum surface 168. The radius of the optic stop structure 170 may range from about 0.25 inches to about 1 inch. The optic mount body 166 may be formed from a lightweight rigid material such as aluminum. Other suitable materials for the optic mount body 166 or any other optic mount body discussed herein may include rigid, stable, high strength materials such as metal alloys including stainless steel, composite materials, ceramic materials and the like.

The low profile single optical mount 164 may also include a leaf spring clamp assembly 174 which is disposed in opposition to the datum surface 168 and which is moveable relative to the datum surface 168 in a direction which is generally perpendicular to the datum surface 168. The leaf spring clamp assembly 174 being configured to releasably and controllably clamp an optical element 12 between at least one contact point 176 of the leaf spring clamp assembly 174 and the datum surface 168. The leaf spring clamp assembly 174 may include a resilient leaf spring 178 which has an inner radial portion 180 which is secured in a fixed relation relative to the optic mount body 166. The leaf spring clamp assembly 174 may also have an outer radial portion 182 which comprises at least one contact point 176 which is disposed in opposition to the datum surface 168 and which is resiliently moveable relative to the datum surface 168. The outer radial portion 182 of the resilient leaf spring 178 may form a preset angle of about 8 degrees to about 12 degrees with respect to the plane of the datum surface 168 when the resilient leaf spring 178 is in a relaxed uncompressed state (analogous to FIG. 14).

The leaf spring clamp assembly 174 may also include a clamp screw 184 which has a threaded shaft 186 that passes through a clearance hole 188 in the resilient leaf spring 178. The threaded shaft 186 may be threadedly engaged with a mating threaded hole 190 in the optic mount body 166 such that tightening the clamp screw 184 overcomes a resilient spring resistance of the leaf spring 178 and forces the outer radial portion 182 of the leaf spring 178 closer to the datum surface 168 in order to releasably clamp an optical element 12 between the contact point 176 and the datum surface 168.

The optic mount body may further include a post mount interface 192 which may be configured as a threaded hole. The resilient leaf spring 178 may incorporate 1-3 contact points 176. Each contact point 176 may be formed from a resilient polymer material (such as nylon) that is softer than the material of an optical element 12 which can be mounted to the low profile single optical mount 164. Alternatively, each contact point 176 may be formed by stamping a protrusion into a thin resilient material of the resilient leaf spring 178 and coating the contact point 176 with a resilient polymer material. The leaf spring clamp assembly 174 may be configured to be manually actuated without the need for tools.

The datum surface 168 may be configured to contact a partial outer edge of an optical element 12 and leave a majority of a perimeter of the optical element 12 free of contact or optical interference from the datum surface 168. The datum surface 168 comprises a surface area that is less than about 15 percent of a usable surface area of an optical element 12 to be mounted. Further the datum surface 168 is configured to accept a round optic, and a maximum radial width of the datum surface 168 is about 5 percent to about 20 percent of a radius of the round optical element 12 to be accepted by the datum surface 168. The datum surface 168 is configured to accept a round optical element 12, and a maximum angular circumferential length of the datum surface 168 may be from about 25 degrees to about 60 degrees.

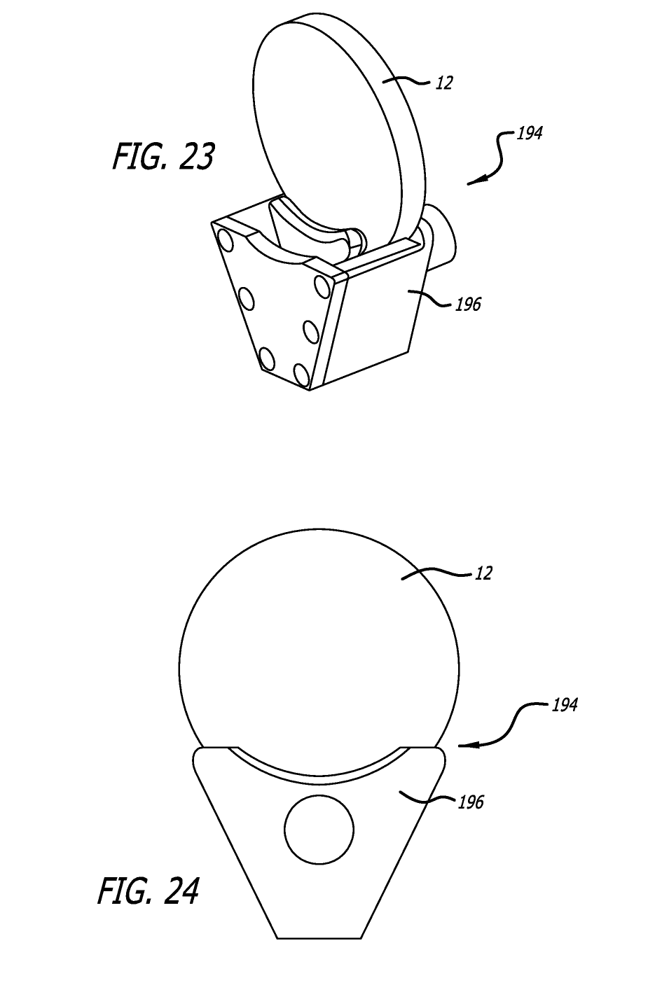

FIGS. 23-26 depict an embodiment of a low profile single optical mount 194 which utilizes a set screw clamp configuration. The low profile single optical mount 194 may incorporate an optic mount body 196. The optic mount body 196 may include a datum surface 198 which is disposed along an outer edge of the optic mount body 196 and which is configured to contact a partial outer surface of an optical element 12 and leave a majority of a perimeter of the optical element free of contact. The optic mount body 196 may also include an optic stop structure 200 which extends from the plane of the datum surface 198 and which is disposed in fixed relation to the datum surface 198. The optic stop structure 200 may bound an inner boundary of the datum surface 198 and may provide a surface against which an outer edge of an optical element 12 to be mounted makes contact. The optic stop structure 200 which provides a physical stop for optical elements 12 may be configured as an arc shaped ridge which extends above the plane of the datum surface 198. The radius of the optic stop structure 200 may range from about 0.25 inches to about 1 inch. The optic mount body 196 may be formed from a lightweight rigid material such as aluminum. Other suitable materials for the optic mount body 196 or any other optic mount body discussed herein may include rigid, stable, high strength materials such as metal alloys including stainless steel, composite materials, ceramic materials and the like.

The low profile single optical mount 194 may also include a guide pin clamp assembly 204 which is disposed in opposition to the datum surface 198 and which is moveable relative to the datum surface 198 in a direction which is generally perpendicular to the datum surface 198. The guide pin clamp assembly 204 being configured to releasably and controllably clamp an optical element between at least one contact point 206 and the datum surface 198. The low profile single optical mount 194 may also include a rigid clamp plate 208 which has an outer radial portion 210 which includes the contact points 206 which are disposed in opposition to the datum surface 198. The clamp plate 208 may be moveable relative to the datum surface 198 in a direction which is substantially perpendicular to the datum surface 198.

The guide pin clamp assembly may also include a clamp screw 212 that rotates relative to the optic mount body 196 while being substantially axially fixed relative to the optic mount body 196. The clamp screw 212 may incorporate a threaded shaft 214 which is threadedly engaged with a threaded hole 216 of the clamp plate 208 such that rotation of the clamp screw 212 induces relative displacement between the clamp plate 208 and the optic mount body 196. Tightening the clamp screw 212 may force the outer radial portion 210 of the clamp plate 208 closer to the datum surface 198 in order to releasably clamp an optical element 12 between each contact point 206 and the datum surface 198 as shown in FIG. 26.

The optic mount body may further include a post mount interface 218 which may be configured as a threaded hole. The clamp plate 208 may incorporate 1-3 contact points 206. Each contact point 206 may be formed from a resilient polymer material (such as nylon) that is softer than the material of an optical element 12 which can be mounted to the low profile single optical mount 194. Alternatively, each contact point 206 may be formed by stamping a protrusion into a thin resilient material of the clamp plate 208 and coating the contact point 206 with a resilient polymer material. The guide pin clamp assembly 204 may be configured to be manually actuated without the need for tools.

The datum surface 198 may be configured to contact a partial outer edge of an optical element 12 and leave a majority of a perimeter of the optical element 12 free of contact or optical interference from the datum surface 198. The datum surface 198 comprises a surface area that is less than about 15 percent of a usable surface area of an optical element 12 to be mounted. Further the datum surface 198 is configured to accept a round optical element 12, and a maximum radial width of each datum surface 198 is about 5 percent to about 20 percent of a radius of the round optical element 12 to be accepted by the datum surface 198. The datum surface 198 is configured to accept a round optical element, and a maximum angular circumferential length of the datum surface 12 may be from about 25 degrees to about 60 degrees.

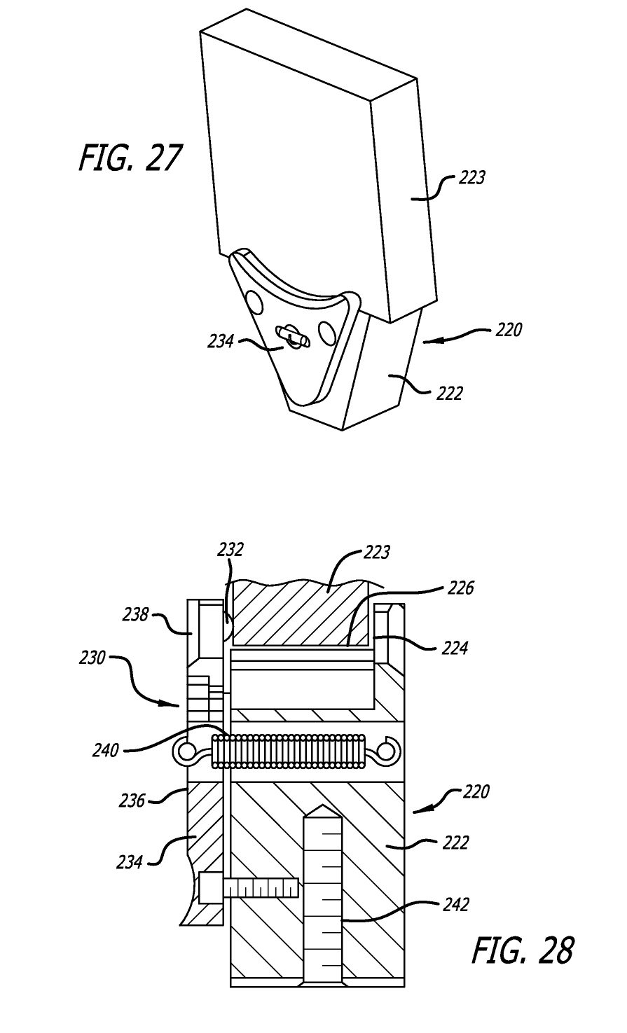

FIGS. 27 and 28 depict an embodiment of a low profile single optical mount 220 which utilizes the tension spring clamp configuration. The low profile single optical mount 220 may incorporate an optic mount body 222. The optic mount body 222 may include a datum surface 224 which is disposed along an outer edge of the optic mount body 222 and which is configured to contact a partial outer surface of an optical element 12 and leave a majority of a perimeter of the optical element 12 free of contact. The optic mount body 222 may also include an optic stop structure 226 which extends from the plane of the datum surface 224 and which is disposed in fixed relation to the datum surface 224. The optic stop structure 226 may bound an inner boundary of the datum surface 224 and may provide a surface against which an outer edge of an optical element 12 to be mounted makes contact. The optic stop structure 226 which provides a physical stop for optical elements 12 may be configured as an arc shaped ridge which extends above the plane of the datum surface 224. The radius of the optic stop structure 226 may range from about 0.25 inches to about 1 inch. The optic mount body 222 may be formed from a lightweight rigid material such as aluminum. Other suitable materials for the optic mount body 222 or any other optic mount body discussed herein may include rigid, stable, high strength materials such as metal alloys including stainless steel, composite materials, ceramic materials and the like.

The low profile single optical mount 220 may also include a tension spring clamp assembly 230 which is disposed in opposition to the datum surface 224 and which is moveable relative to the datum surface 224 in a direction which is generally perpendicular to the datum surface 224. The tension spring clamp assembly 230 may be configured to releasably and controllably clamp an optical element 12 between at least one contact point 232 and the datum surface 224. The tension spring clamp assembly 230 may include a rigid clamp plate 234 which has an inner radial portion 236 which is disposed in a pivoting but axially fixed relation relative to the optic mount body 222. The clamp plate 234 may also include an outer radial portion 238 which comprises at least one contact point 232 which is disposed in opposition to the datum surface 224 and which is moveable relative to the datum surface 224.

The tension spring clamp assembly 230 may also include a resilient tension member 240 which is operatively coupled between the optic mount body 222 and the clamp plate 234. The resilient tension member 240 is configured to exert a resilient bias clamping tension between the optic mount body 222 and the clamp plate 234 that pulls the outer radial portion 238 of the clamp plate 234 closer to the datum surface 224 in order to releasably clamp an optical element 12 between each contact point 232 and the datum surface 224 as shown in FIG. 28.

The optic mount body may further include a post mount interface 242 which may be configured as a threaded hole. The clamp plate 234 may incorporate 1-3 contact points 232. Each contact point 232 may be formed from a resilient polymer material (such as nylon) that is softer than the material of an optical element 12 which can be mounted to the low profile single optical mount 220. Alternatively, each contact point 232 may be formed by stamping a protrusion into a thin resilient material of the clamp plate 234 and coating the contact point 232 with a resilient polymer material. The tension spring assembly 230 may be configured to be manually actuated without the need for tools.

The datum surface 224 may be configured to contact a partial outer edge of an optical element 12 and leave a majority of a perimeter of the optical element 12 free of contact or optical interference from the datum surface 224. The datum surface 224 comprises a surface area that is less than about 15 percent of a usable surface area of an optical element 12 to be mounted. Further the datum surface 224 is configured to accept a round optical element, and a maximum radial width of each datum surface is about 5 percent to about 20 percent of a radius of the round optical element 12 to be accepted by the datum surface 224. The datum surface 224 is configured to accept a round optical element 12, and a maximum angular circumferential length of the datum surface 224 may be from about 25 degrees to about 60 degrees.

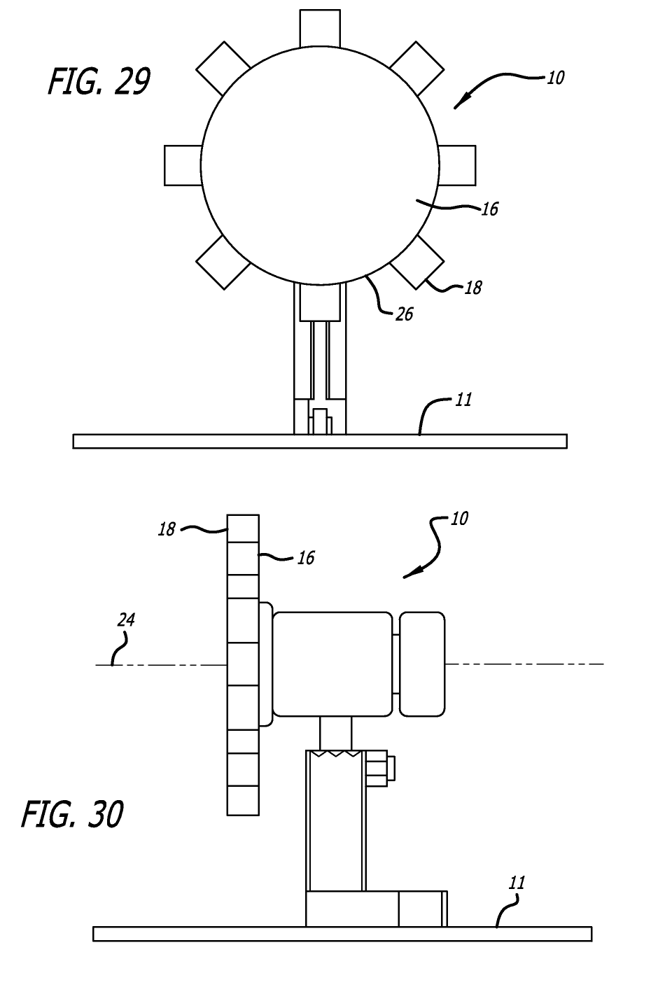

Referring again to the low interference optical mount assembly 10 of FIG. 1, although this embodiment is shown with integrally formed optical mounts 18 using a monolithic leaf spring configuration 124, any other suitable optical mounts that minimize optical interference may also be used for the same or similar configuration. FIGS. 29 and 30 show a schematic representation of the optical mount assembly 10 with a plurality of optic mounts 18 securely and rigidly disposed about an outer perimeter 26 of the rotating support frame 16 of the assembly. This plurality of optical mounts 18 may be fully or partially integrally formed as discussed above, but other optical mount embodiments may also be so integrally formed or formed separately and rigidly secured to the rotating support frame 16 by any suitable means such as fasteners, adhesives, welding, brazing, soldering or the like. For example, any of the individual optical mount embodiments, such as shown in FIGS. 20-28, may be so rigidly secured about the support frame to form an optical mount assembly essentially as shown in FIG. 1 and having all or some of the same features, dimensions, materials, etc.

More specifically, another embodiment of a clamp (along with an associated optical mount) which may be used in conjunction with the low interference optical mount assembly 10 is illustrated in FIGS. 23-26. The guide pin clamp assembly 204 may include a clamp plate 208 which has an outer radial portion 210 which comprises at least one contact point 206 which is disposed in opposition to a datum surface 198. The clamp plate 208 may be moveable relative to the datum surface 198 in a direction which is substantially perpendicular to the datum surface 198. The guide pin clamp assembly 204 may also include a clamp screw 212 that rotates relative to an optic mount body 196 while being substantially axially fixed relative to the optic mount body 196. The clamp screw 212 may have a threaded shaft 214 which is threadedly engaged with a threaded hole 216 of the clamp plate 208. Rotation of the clamp screw 212 will induce a relative displacement between the clamp plate 212 and the optic mount body 196 in that tightening the clamp screw 212 will force the outer radial portion 210 of the clamp plate 208 closer to the datum surface 198 to releasably clamp an optical element 12 between the contact point 206 and the datum surface 198 as shown in FIG. 26.

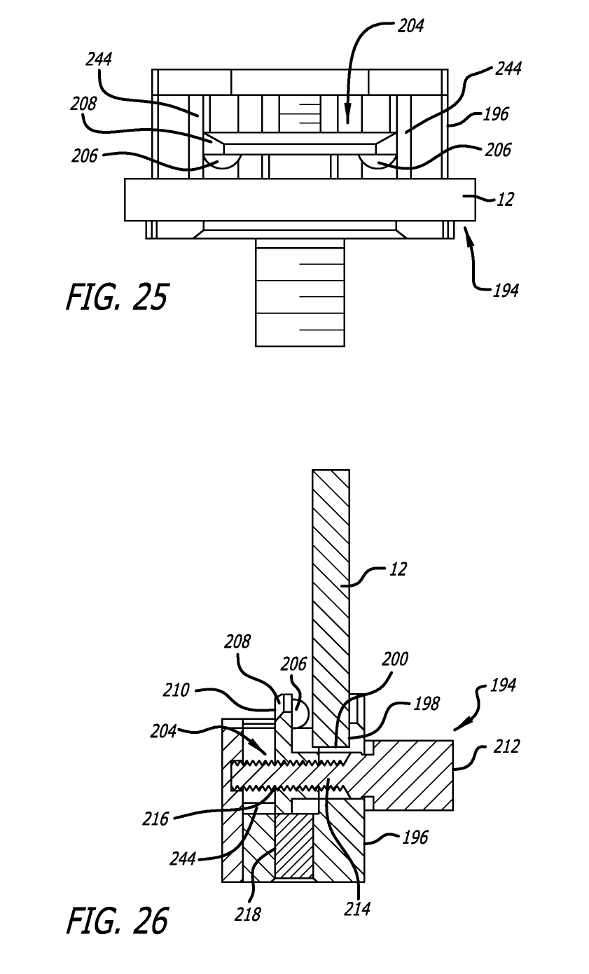

The guide pin clamp assembly 204 may further include multiple guide pins 244 which may be secured in fixed relation to the optic mount body 196. Each guide pin 244 may extend through a closely fitting respective hole in the clamp plate 208 (see FIGS. 25 and 26). The guide pins 244 allow for movement of the clamp plate 208 which is parallel to a longitudinal axis of the clamp screw 212, but restrict the movement of the clamp plate 208 in all other axes of displacement. The optic mount body 196, the clamp plate 208 and clamp screw 212 may be configured to provide about 1 mm to about 10 mm of relative separation between the datum surface 198 and the contact points 206.

Another embodiment of a clamp (along with an associated optical mount) which may be used in conjunction with the low interference optical mount assembly 10 is illustrated in FIGS. 27 and 28. The embodiment is configured as a tension spring clamp assembly 230. The tension spring clamp assembly 230 may include a clamp plate 234 which has an inner radial portion 236 which is configured in a pivoting but axially fixed relation relative to an optic mount body 222. The clamp plate 234 may further include an outer radial portion 238 which includes multiple contact points 232 which are disposed in opposition to a datum surface 224. The clamp plate 234 may further be configured such that it is moveable relative to the datum surface 224.

The tension spring clamp embodiment 230 may further include a resilient tension member 240 which is operatively coupled between the optic mount body 222 and the clamp plate 234. The resilient tension member 240 may be configured to exert a resilient bias clamping tension between the optic mount body 222 and the clamp plate 234. The resilient bias clamping tension may pull the outer radial portion 238 of the clamp plate 234 closer to the datum surface 224 in order to releasably clamp an optic element 12 between the contact points 232 and the datum surface 224 as shown in FIG. 28. The tension spring clamp embodiment 230 may be configured such that a separation distance between the contact points 232 and the datum surface 224 is greater than a width of an optical element 12 which is to be mounted when the clamp plate 234 is in a fully retracted state of separation from the optic mount body 222. Further, the optic mount body 222, the clamp plate 234 and the resilient tension member 240 may be configured to provide about 1 mm to about 10 mm of relative separation between the datum surface 224 and the contact points 232. The resilient tension member 240 may be configured as a coil spring.

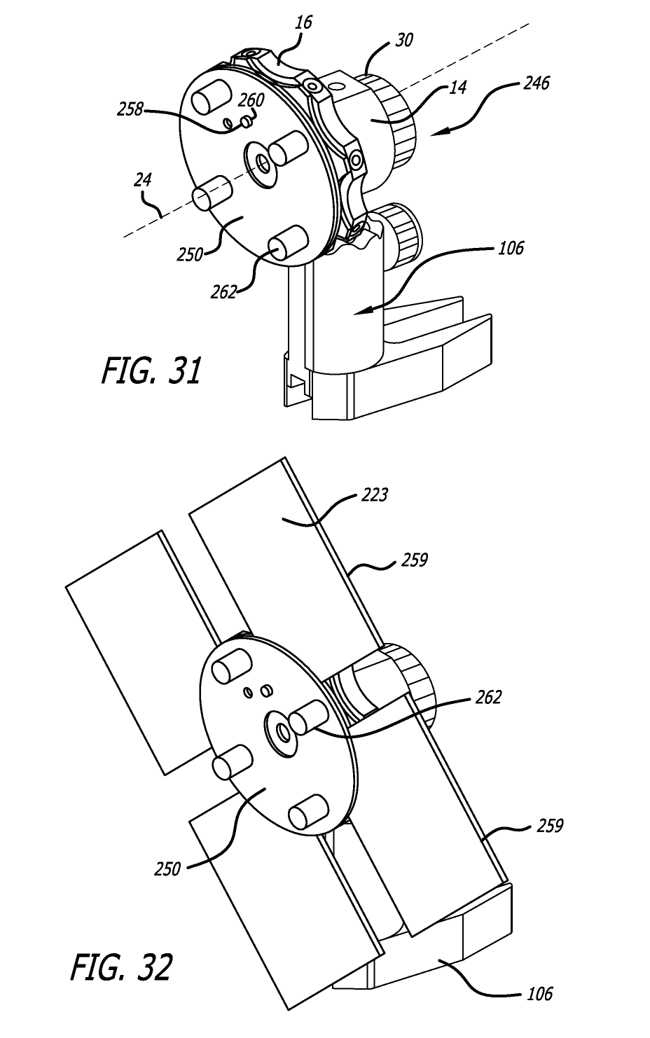

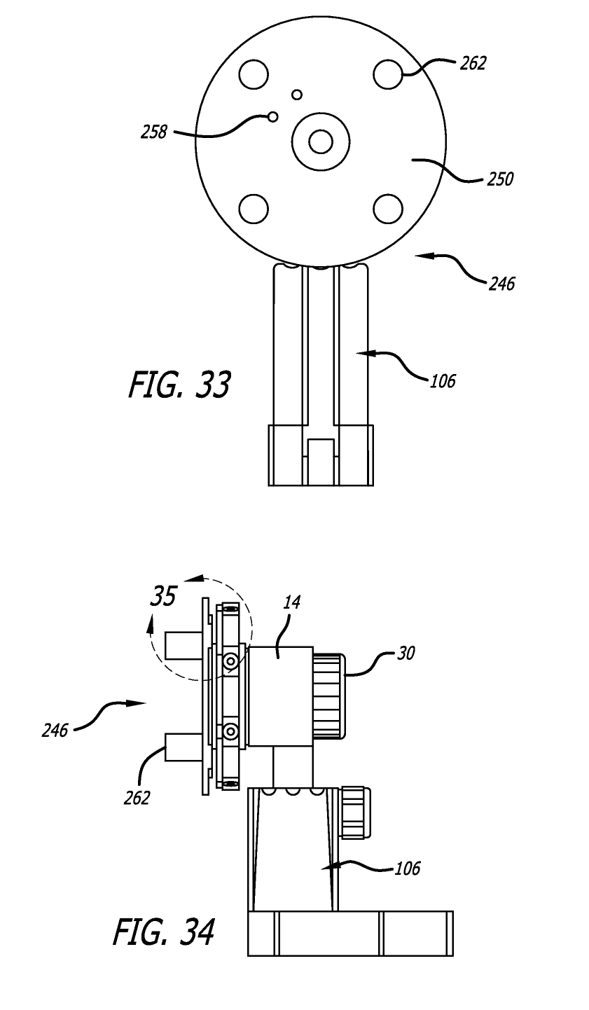

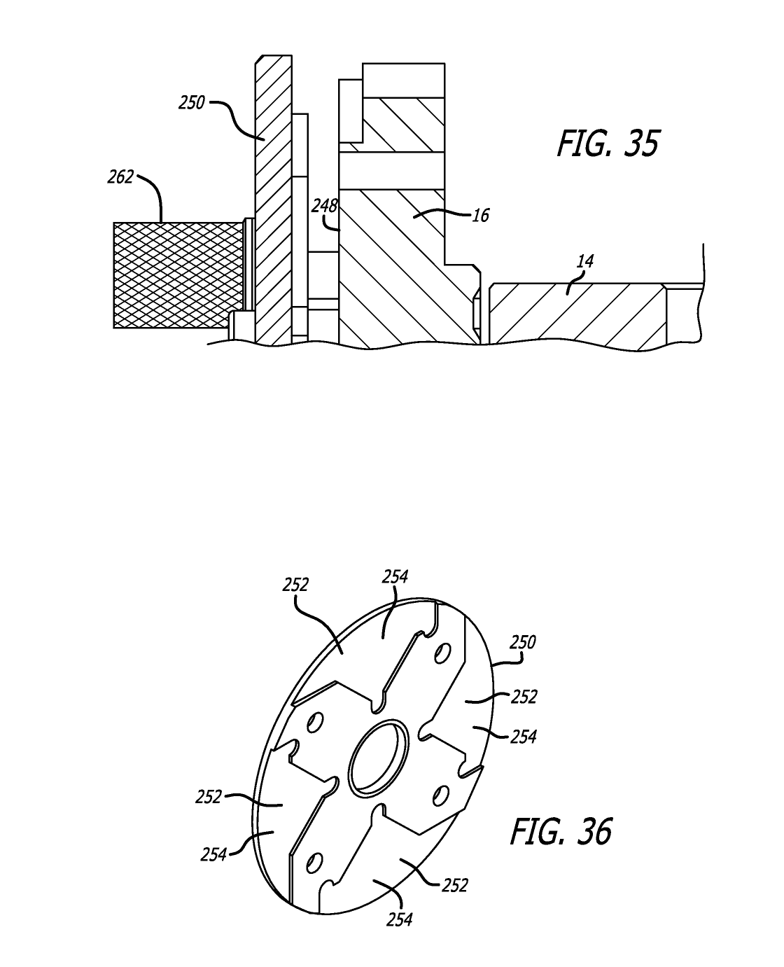

Another embodiment of a low interference optical mount assembly 246 is depicted in FIGS. 31-35. The low interference optical mount assembly 246 may include many of the same components as the low interference optical mount assembly 10. The low interference optical mount assembly 246 may include the optical post assembly 106 and the base member 14. The low interference optical assembly 246 may also include the rigid rotating support plate 16 which is rotatably coupled to the base member 14 and which is configured to rotate about the axis of rotation 24 of the rotating support plate 16. The rotating support plate 16 may include a datum surface 248 which is disposed on a front surface 249 (see FIG. 7) of the rotating support plate 16 (see FIG. 7). The datum surface 248 may lie in a plane which is substantially perpendicular to the axis of rotation 24.

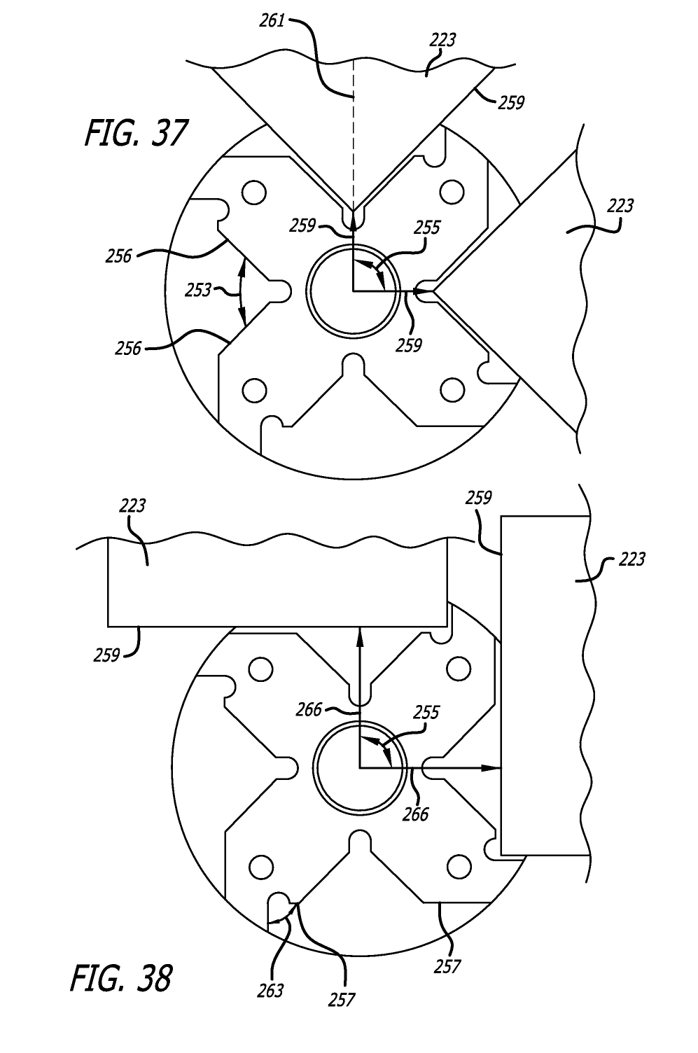

The low interference optical mount assembly 246 may also include a clamp plate 250 which is disposed adjacent to the rotating support plate 16 and which is configured to releasably and controllably clamp an optical element 223 to the datum surface 248. The clamp plate 250 may be moveable relative to the datum surface 248 in a direction which is generally perpendicular to the datum surface 248. The clamp plate 250 may include a plurality of optic receptacles 252 with each optic receptacle 252 including a contact surface 254 which is disposed in opposition to the datum surface 248. Each optic receptacle 252 may be configured to engage a partial outer edge of an optical element 223 and leave a majority of a perimeter of the optical element 223 free of contact. For some embodiments the optical receptacles 252 may be integrally formed into the clamp plate 250. The clamp plate 250 may incorporate from about 2 to about 10 optical receptacles 252 which may be evenly spaced about the clamp plate 250. The angular circumferential separation 255 (see FIG. 37) between each optical receptacle 252 may be configured such that the clamp plate 250 remains compact and yet will still allow for the manual mounting and removing of optical elements 223 from the optical receptacles 252 while gripping the optical elements 223 from the edges. The base member 14, rotating support plate 16, and clamp plate 250 may be fabricated from any suitable lightweight rigid material such as aluminum. Other suitable materials for these components 14, 16, and 250 may include rigid, stable, high strength materials such as metal alloys including stainless steel, composite materials, ceramic materials and the like.

Each optic receptacle 252 may include a first optic stop structure 256 and a second optic stop structure 257. The first optic stop structure 256 may extend from a plane of the contact surface 254, with the first optic stop structure 256 being disposed in fixed relation to the contact surface 254. The second optic stop structure 257 may also extend from a plane of the contact surface 254, with the second optic stop structure 257 also being disposed in fixed relation to the contact surface 254.

The first optic stop structure 256 may be configured as a ridge structure that extends above the plane of the contact surface 254 and that has a v-shaped configuration with an interior angle 253 of about 85 degrees to about 95 degrees. FIG. 37 depicts multiple optical elements 223 which are mounted into multiple optical receptacles 252 of the clamp plate 250 using multiple first optic stop structures 256. Each optical element 223 which is mounted to a respective optic stop structure 256 may be radially disposed at a distance of a first element radius 259 from the axis of rotation 24. Each optical element 223 which is mounted in a respective optic stop structure 256 may be circumferentially disposed at an angular circumferential separation 255 (about the axis of rotation 24) from each adjacent optical element 223. The first optic stop structure may be configured to contact multiple outer surfaces 259 (see FIG. 32) of an optical element 223 such that a diagonal 261 of the optical element 223 is substantially parallel to a respective first element radius 259 of the optical element 223.

The second optic stop structure 257 may be configured as a ridge structure that extends above the plane of the contact surface 254 and that has a v-shaped configuration with an interior angle 263 of about 85 degrees to about 95 degrees. FIG. 37 depicts multiple optical elements 223 which are mounted into multiple optical receptacles 252 of the clamp plate 250 using multiple second optic stop structures 257. Each optical element 223 which is mounted to a respective optic stop structure 257 may be radially disposed at a distance of a second element radius 266 from the axis of rotation 24. Each optical element 223 which is mounted in a respective optic stop structure 256 may be circumferentially disposed at an angular circumferential separation 255 (about the axis of rotation 24) from each adjacent optical element 223. The second optic stop structure 257 may be configured to contact multiple outer surfaces 259 (see FIG. 32) of an optical element 223 such that at least one outer surface 259 of the optical element 223 is substantially perpendicular to a respective second element radius 266 of the optical element 223.

The low interference optical mount assembly 246 may also include a guide pin 258 which is secured in a fixed relation to the rotating support plate 16 and which extends from a face of the rotating support plate 16. The guide pin 258 may be slidingly coupled to a hole 260 in the clamp plate 250 in order to circumferentially align the clamp plate 250 to the rotating support plate 16 and to prevent relative rotation between the clamp plate 250 and the rotating support plate 16 around the axis of rotation 24. The contact surface 254 of each optical receptacle 252 may be configured to have a surface area that is less that about 15 percent of a useable surface area of an optical element 12 which is to be mounted to each respective optic receptacle 252. The low interference optical mount assembly 246 may also include a clamp mechanism that is operatively coupled between the clamp plate 250 and the rotating support plate 16. For the low interference optical mount assembly of FIG. 31, the clamp mechanism is configured as a manually operated set screw 262. The set screw 262 may be configured to controllably compress the contact surfaces 254 of the clamp plate towards the datum surface 248 of the rotating support plate 16.

The rotating support plate 16 may be rotatably secured to the base member 14 in a manner which is analogous to that which was described for the embodiments shown in FIG. 13 wherein the frame adjustment knob 30 is secured to the rotating support plate 16 by the shaft 140 which passes through the lubricious bearing 132. The interface between the rotating support plate 16 and the base member 14 may include at least one ball detent apparatus which incorporates an angular circumferential detent spacing that is configured to match an angular circumferential spacing of the plurality optic receptacles 252. Said ball detent apparatus may be the same as or similar to the ball detent apparatus 268 discussed above. The ball detent apparatus between the rotating support plate 14 and the base member 14 is configured such that the rotating support frame 16 can be manually rotated without the use of tools relative the base member 14 about the axis of rotation 24 in an indexed configuration that has indexing which is configured to match a circumferential spacing of the plurality of optical receptacles 252 as has been discussed previously for the low interference optical mount assembly 10. The base member 14 may include at least one threaded hole which is perpendicular to the axis of rotation 24, with the threaded hole being configured to be conveniently mounted to an optical post 148.

The low interference optical mount assembly 246 may be configured with an outer guard ring 156 in a manner which is analogous to the embodiments which are shown in FIG. 17. The outer guard ring 156 may be configured to protect optical elements 12 which are mounted to the low interference optical mount assembly 246 from damage. The outer guard ring 156 may include an aperture 158 which has a transverse dimension which is sized to clear an outer radial edge of all optical elements 12 which are mounted in the respective optic mounts of the low interference optical mount assembly 246. The outer guard ring 156 may be secured to the rotating support plate 16 by one or more radial extension members 162 that are sized to fit between the optical elements 12 mounted in the respective optic receptacles 252.

With regard to the above detailed description, like reference numerals used therein may refer to like elements that may have the same or similar dimensions, materials and configurations. While particular forms of embodiments have been illustrated and described, it will be apparent that various modifications can be made without departing from the spirit and scope of the embodiments of the invention. Accordingly, it is not intended that the invention be limited by the forgoing detailed description.

The entirety of each patent, patent application, publication and document referenced herein is hereby incorporated by reference. Citation of the above patents, patent applications, publications and documents is not an admission that any of the foregoing is pertinent prior art, nor does it constitute any admission as to the contents or date of these documents.

Modifications may be made to the foregoing embodiments without departing from the basic aspects of the technology. Although the technology may have been described in substantial detail with reference to one or more specific embodiments, changes may be made to the embodiments specifically disclosed in this application, yet these modifications and improvements are within the scope and spirit of the technology. The technology illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the technology claimed. The term “a” or “an” may refer to one of or a plurality of the elements it modifies (e.g., “a reagent” can mean one or more reagents) unless it is contextually clear either one of the elements or more than one of the elements is described. Although the present technology has been specifically disclosed by representative embodiments and optional features, modification and variation of the concepts herein disclosed may be made, and such modifications and variations may be considered within the scope of this technology.

Certain embodiments of the technology are set forth in the claim(s) that follow(s).

What is claimed is:

1. A low interference optical mount assembly for mounting a plurality of optics, comprising:
a base member;
a rigid rotating support frame rotatably coupled to the base member and configured to rotate about a rotation axis of the support frame; and
a plurality of low interference optic mounts circumferentially disposed about and in fixed relation to the support frame at a common radius from the axis of rotation, each low interference optic mount comprising:
an optic mount body,
a datum surface which is disposed along an outer radial edge of the optic mount body, which lies in a plane perpendicular to the axis of rotation, and which is configured to contact a partial outer edge of an optic and leave a majority of a perimeter of an optic free of contact,
an optic stop structure which extends from the plane of the datum surface, which is disposed in fixed relation to the datum surface, which bounds an inner radial boundary of the datum surface and which provides a surface against which an outer edge of an optic to be mounted makes contact, and
a clamp with at least one contact point which is disposed in opposition to the datum surface, which is moveable relative to the datum surface in a direction generally perpendicular to the datum surface and which is configured to releasably and controllably clamp an optic between the at least one contact point and the datum surface.

2. The low interference optical mount assembly of claim 1 wherein each clamp comprises:
a resilient leaf spring having an inner radial portion secured in fixed relation relative to the optic mount body and an outer radial portion which comprises the at least one contact point disposed in opposition to the datum surface and which is resiliently moveable relative to the datum surface, and
a clamp screw which has a threaded shaft that passes through a clearance hole in the leaf spring and which is threadedly engaged with a mating threaded hole in the optic mount body such that tightening the clamp screw overcomes a resilient spring resistance of the leaf spring and forces the outer radial portion of the leaf spring closer to the datum surface to releasably clamp an optic between the at least one contact point and the datum surface.

3. The low interference optical mount assembly of claim 2 wherein the resilient leaf springs of the plurality of optic mounts are all included in a monolithic leaf spring member, the monolithic leaf spring member being formed from a single piece of thin resilient material with the inner radial portion of each resilient leaf spring extending from a central hub of the monolithic leaf spring member and adjacent leaf springs being separated by a radially oriented slot that extends from the hub to an outer radial edge of the monolithic leaf spring member so as to permit substantially independent compression of each resilient leaf spring of the monolithic leaf spring member.

4.

5. The low interference optical mount assembly of claim 3 wherein the inner radial portion of each resilient leaf spring is secured in fixed relation to the optic mount body by a compression force exerted by the clamp screws of each of the other resilient leaf springs.

6-8. (canceled)

9. The low interference optical mount assembly of claim 2 wherein the outer radial portion of each resilient leaf spring forms a preset angle of about 8 degrees to about 12 degrees with respect to the plane of the datum surface when the resilient leaf spring is in a relaxed uncompressed state.

10. The low interference optical mount assembly of claim 1 wherein each clamp comprises:
a clamp plate having an outer radial portion which comprises the at least one contact point disposed in opposition to the datum surface and which is moveable relative to the datum surface in a direction substantially perpendicular to the datum surface, and
a clamp screw that rotates relative to the optic mount body while being substantially axially fixed relative to the optic mount body and which has a threaded shaft that is threadedly engaged with a threaded hole of the clamp plate such that rotation of the clamp screw induces relative displacement between the clamp plate and the optic mount body and such that tightening the clamp screw forces the outer radial portion of the clamp plate closer to the datum surface to releasably clamp an optic between the at least one contact point and the datum surface.

11-13. (canceled)

14. The low interference optical mount assembly of claim 1 wherein each clamp comprises:
a clamp plate having an inner radial portion in a pivoting but axially fixed relation relative to the optic mount body and an outer radial portion which comprises the at least one contact point disposed in opposition to the datum surface and which is moveable relative to the datum surface, and
a resilient tension member operatively coupled between the optic mount body and clamp plate and configured to exert a resilient bias clamping tension between the optic mount body and the clamp plate that pulls the outer radial portion of the clamp plate closer to the datum surface to releasably clamp an optic between the at least one contact point and the datum surface.

15-29. (canceled)

30. The low interference optical mount assembly of claim 1 wherein the support frame comprises a rigid support plate rigidly secured to a hub that is configured to rotate about the axis of rotation within a bore of the base member.

31. (canceled)

32. The low interference optical mount assembly of claim 1 wherein the optic stop structure comprises a ridge that extends above the plane of the datum surface, the ridge forming a surface that faces generally radially outward from the axis of rotation.

33-41. (canceled)

42. The low interference optical mount assembly of claim 1 wherein each datum surface which is configured to contact a partial outer edge of an optic and leave a majority of a perimeter of an optic free of contact or optical interference from the datum surface comprises a surface area that is less than about 15 percent of a usable surface area of an optic to be mounted in each respective optic mount.

43. The low interference optical mount assembly of claim 1 wherein each datum surface which is configured to contact a partial outer edge of an optic and leave a majority of a perimeter of an optic free of contact or optical interference from the datum surface comprises a surface area that is less than about 10 percent of a usable surface area of an optic to be mounted in each respective optic mount.

44. The low interference optical mount assembly of claim 1 wherein each datum surface is configured to accept a round optic and a maximum radial width of each datum surface is about 5 percent to about 20 percent of a radius of the round optic to be accepted by the datum surface.

45. The low interference optical mount assembly of claim 1 wherein the datum surface is configured to accept a round optic and a maximum angular circumferential length of the datum surface is about 25 degrees to about 60 degrees.

46. The low interference optical mount assembly of claim 1 further comprising a thin outer guard ring which has an aperture with a transverse dimension sized to clear an outer radial edge of all optics mounted in the respective optic mounts and which is secured to the support frame by one or more radial extension members that are sized to fit between optics mounted in the optic mounts.

47. A low interference optic mount, comprising:
an optic mount body;
a datum surface which is disposed along an outer edge of the optic mount body and which is configured to contact a partial outer surface of an optic and leave a majority of a perimeter of an optic free of contact;
an optic stop structure which extends from the plane of the datum surface, which is disposed in fixed relation to the datum surface, which bounds an inner boundary of the datum surface and which provides a surface against which an outer edge of an optic to be mounted makes contact; and
a clamp which is disposed in opposition to the datum surface, which is moveable relative to the datum surface in a direction generally perpendicular to the datum surface and which is configured to releasably and controllably clamp an optic between at least one contact point thereof and the datum surface, the clamp further comprising:
a resilient leaf spring having an inner radial portion secured in fixed relation relative to the optic mount body and an outer radial portion which comprises the at least one contact point disposed in opposition to the datum surface and which is resiliently moveable relative to the datum surface, and
a clamp screw which has a threaded shaft that passes through a clearance hole in the resilient leaf spring and which is threadedly engaged with a mating threaded hole in the optic mount body such that tightening the clamp screw overcomes a resilient spring resistance of the leaf spring and forces the outer radial portion of the leaf spring closer to the datum surface to releasably clamp an optic between the at least one contact point and the datum surface.

48-49. (canceled)

50. The low interference optic mount of claim 47 wherein the outer radial portion of the resilient leaf spring forms a preset angle of about 8 degrees to about 12 degrees with respect to the plane of the datum surface when the resilient leaf spring is in a relaxed uncompressed state.

51-56. (canceled)

57. The low interference optic mount of claim 47 wherein the optic stop structure comprises a ridge that extends above the plane of the datum surface.

58. The low interference optic mount of claim 57 wherein a surface contour of the ridge has a circular arc configuration.

59-61. (canceled)

62. The low interference optic mount of claim 47 wherein the datum surface which is configured to contact a partial outer edge of an optic and leave a majority of a perimeter of an optic free of contact or optical interference from the datum surface comprises a surface area that is less than about 15 percent of a usable surface area of an optic to be mounted in each respective optic mount.

63. The low interference optic mount of claim 47 wherein the datum surface which is configured to contact a partial outer edge of an optic and leave a majority of a perimeter of an optic free of contact or optical interference from the datum surface comprises a surface area that is less than about 10 percent of a usable surface area of an optic to be mounted.

64. The low interference optic mount of claim 47 wherein the datum surface is configured to accept a round optic and a maximum radial width of each datum surface is about 5 percent to about 20 percent of a radius of the round optic to be accepted by the datum surface.

65. The low interference optic mount of claim 47 wherein the datum surface is configured to accept a round optic and a maximum angular circumferential length of the datum surface is about 25 degrees to about 60 degrees.

66. A low interference optic mount, comprising:
an optic mount body;
a datum surface which is disposed along an outer edge of the optic mount body and which is configured to contact a partial outer surface of an optic and leave a majority of a perimeter of an optic free of contact;
an optic stop structure which extends from the plane of the datum surface, which is disposed in fixed relation to the datum surface, which bounds an inner boundary of the datum surface and which provides a surface against which an outer edge of an optic to be mounted makes contact; and
a clamp which is disposed in opposition to the datum surface, which is moveable relative to the datum surface in a direction generally perpendicular to the datum surface and which is configured to releasably and controllably clamp an optic between at least one contact point thereof and the datum surface, the clamp further comprising:
a rigid clamp plate having an outer radial portion which comprises the at least one contact point disposed in opposition to the datum surface and which is moveable relative to the datum surface in a direction substantially perpendicular to the datum surface, and
a clamp screw that rotates relative to the optic mount body while being substantially axially fixed relative to the optic mount body and which has a threaded shaft that is threadedly engaged with a threaded hole of the clamp plate such that rotation of the clamp screw induces relative displacement between the clamp plate and the optic mount body and such that tightening the clamp screw forces the outer radial portion of the clamp plate closer to the datum surface to releasably clamp an optic between the at least one contact point and the datum surface.

67-73. (canceled)

74. The low interference optic mount of claim 66 wherein the optic stop structure comprises a ridge that extends above the plane of the datum surface.

75. The low interference optic mount of claim 74 wherein a surface contour of the ridge is circular.

76-78. (canceled)

79. The low interference optic mount of claim 66 wherein the datum surface which is configured to contact a partial outer edge of an optic and leave a majority of a perimeter of an optic free of contact or optical interference from the datum surface comprises a surface area that is less than about 15 percent of a usable surface area of an optic to be mounted in each respective optic mount.

80. The low interference optic mount of claim 66 wherein the datum surface which is configured to contact a partial outer edge of an optic and leave a majority of a perimeter of an optic free of contact or optical interference from the datum surface comprises a surface area that is less than about 10 percent of a usable surface area of an optic to be mounted.

81. The low interference optic mount of claim 66 wherein the datum surface is configured to accept a round optic and a maximum radial width of each datum surface is about 5 percent to about 20 percent of a radius of the round optic to be accepted by the datum surface.

82. The low interference optic mount of claim 66 wherein the datum surface is configured to accept a round optic and a maximum angular circumferential length of the datum surface is about 25 degrees to about 60 degrees.

83. A low interference optic mount, comprising:
an optic mount body;
a datum surface which is disposed along an outer edge of the optic mount body and which is configured to contact a partial outer surface of an optic and leave a majority of a perimeter of an optic free of contact;
an optic stop structure which extends from the plane of the datum surface, which is disposed in fixed relation to the datum surface, which bounds an inner boundary of the datum surface and which provides a surface against which an outer edge of an optic to be mounted makes contact; and
a clamp which is disposed in opposition to the datum surface, which is moveable relative to the datum surface in a direction generally perpendicular to the datum surface and which is configured to releasably and controllably clamp an optic between at least one contact point thereof and the datum surface, the clamp further comprising:
a rigid clamp plate having an inner radial portion in a pivoting but axially fixed relation relative to the optic mount body and an outer radial portion which comprises the at least one contact point disposed in opposition to the datum surface and which is moveable relative to the datum surface, and
a resilient tension member operatively coupled between the optic mount body and clamp plate and configured to exert a resilient bias clamping tension between the optic mount body and the clamp plate that pulls the outer radial portion of the clamp plate closer to the datum surface to releasably clamp an optic between the at least one contact point and the datum surface.

84-90. (canceled)

91. The low interference optic mount of claim 83 wherein the optic stop structure comprises a ridge that extends above the plane of the datum surface.

92. The low interference optic mount of claim 91 wherein a surface contour of the ridge is circular.

93-95. (canceled)

96. The low interference optic mount of claim 83 wherein the datum surface which is configured to contact a partial outer edge of an optic and leave a majority of a perimeter of an optic free of contact or optical interference from the datum surface comprises a surface area that is less than about 15 percent of a usable surface area of an optic to be mounted in each respective optic mount.

97. The low interference optic mount of claim 83 wherein the datum surface which is configured to contact a partial outer edge of an optic and leave a majority of a perimeter of an optic free of contact or optical interference from the datum surface comprises a surface area that is less than about 10 percent of a usable surface area of an optic to be mounted.

98. The low interference optic mount of claim 83 wherein the datum surface is configured to accept a round optic and a maximum radial width of each datum surface is about 5 percent to about 20 percent of a radius of the round optic to be accepted by the datum surface.

99. The low interference optic mount of claim 83 wherein the datum surface is configured to accept a round optic and a maximum angular circumferential length of the datum surface is about 25 degrees to about 60 degrees.

100. A low interference optical mount assembly for mounting a plurality of optics, comprising:
a base member;
a rigid rotating support plate which is rotatably coupled to the base member, which is configured to rotate about a rotation axis of the support plate, and which includes a datum surface disposed along an outer radial edge of the support plate, the datum surface lying in a plane which is substantially perpendicular to the axis of rotation;
a clamp plate which is disposed adjacent the support plate and configured to releasably and controllably clamp an optic to the datum surface, which is moveable relative to the datum surface in a direction generally perpendicular to the datum surface and which includes a plurality of optic receptacles with each optic receptacle including a contact surface disposed in opposition to the datum surface, each optic receptacle being configured to engage a partial outer edge of an optic and leave a majority of a perimeter of an optic free of contact and each optic receptacle including an optic stop structure that extends from a plane of the contact surface, that is disposed in fixed relation to the contact surface, that bounds an inner radial boundary of the contact surface and that provides a surface against which an outer edge of an optic to be mounted makes contact; and
a clamp mechanism that is operatively coupled between the clamp plate and the support plate and is configured to controllably compress the contact surfaces of the clamp plate towards the datum surface of the support plate.

101. The low interference optical mount assembly of claim 100 wherein the clamp mechanism comprises a manually operated set screw.

102. (canceled)

103. The low interference optical mount assembly of claim 100 wherein the optic receptacles are integrally formed into the clamp plate.

104-105. (canceled)

106. The low interference optical mount assembly of claim 100 wherein the support plate is rigidly secured to a hub that is configured to rotate about the axis of rotation within a bore of the base member.

107. The low interference optical mount assembly of claim 100 wherein each optic stop structure comprises a ridge that extends above the plane of the contact surface and that has a v-shaped configuration with an interior angle of about 85 degrees to about 95 degrees.

108. The low interference optical mount assembly of claim 100 wherein each optic stop structure comprises a ridge that extends above the plane of the contact surface and that has a circular arc configuration.

109-114. (canceled)

115. The low interference optical mount assembly of claim 100 wherein the contact surface of each optic receptacle comprises a surface area that is less than about 15 percent of a usable surface area of an optic to be mounted in each respective optic receptacle.

116. The low interference optical mount assembly of claim 100 wherein the contact surface of each optic receptacle comprises a surface area that is less than about 10 percent of a usable surface area of an optic to be mounted in each respective optic receptacle.

117. The low interference optical mount assembly of claim 100 further comprising a thin outer guard ring which has an aperture with a transverse dimension sized to clear an outer radial edge of all optics mounted in the respective optic mounts and which is secured to the support plate by one or more radial extension members that are sized to fit between optics mounted in the optic receptacles.
